(19) United States
(12) Patent Application Publication
(10) Pub. No.: US 2019/0340550 A1
(43) Pub. Date: Nov. 7, 2019

(54) CUSTOMIZED LABOR DEMAND ALLOCATION SYSTEM

(71) Applicant: Walmart Apollo, LLC, Bentonville, AR (US)

(72) Inventors: Forest Denger, Fayetteville, AR (US); Mark Steven Malin, JR., Baton Rough, LA (US); Brandon Gardner, Bentonville, AR (US); Craig Hamilton, Centerton, AR (US); Joshua Neal French, Bella Vista, AR (US); Raphael Rose, Bentonville, AR (US); Kevin Reed, Bentonville, AR (US)

(21) Appl. No.: 16/404,675

(22) Filed: May 6, 2019

Related U.S. Application Data
(60) Provisional application No. 62/668,095, filed on May 7, 2018.

(51) Int. Cl. G06Q 10/06; G06Q 10/04

(52) U.S. Cl. CPC G06Q 10/06312; G06Q 10/04; G06Q 10/06316; G06Q 10/06311

(57) ABSTRACT

Examples provide a system for budget-driven labor demand allocation to roles and/or tasks associated with a selected location. A labor demand splitter analyzes a budget plan for a role and live metric data, including weekly delivery schedules and predicted foot traffic, using a set of per-role configuration criteria, forecast metrics, and per-role metric weights. A month splitter and/or a week splitter allocates hours to each day based on the analysis. An intra-day splitter spreads the hours across a set of time-segments for a selected day based on a selected forecast spreading routine, such as an end-points spreading routine or a mid-point spreading routine. The labor demand splitter performs rounding, smoothing, edge-filling and/or coverage fill to generate a set of per-role allocation hours for each day during a selected time-period. The per-role allocation hours are output if it conforms with the goal hours specified by the budget plan.

### BACKGROUND

Current workforce management and scheduling tasks frequently consume significant amounts of resources and bandwidth to build a workforce workflow model, attempt to align that model with a labor budget, and then perform scheduling of worker shifts from an operations standpoint. The created schedules frequently do not match the budget. For example, the hours scheduled for a role, such as a cashier, can be over-budget (too many hours scheduled) or under-budget. Even if the schedule adheres the budget, it cannot satisfy demand. For example, at a given day or time-period within a day, the schedule can provide for too many cashiers (idle cashiers). In other examples, the schedule for cashiers can satisfy the budget but provide insufficient cashiers on a given day and/or time to meet demand. Moreover, current systems generate demand at fifteen-minute intervals for the whole system. This is a very resource intensive and time-consuming procedure, which frequently results in unreliable allocations, inefficient utilization of resources, unnecessary expense, budgeting problems, under-utilized or over-utilized employees, as well as potential user frustration where scheduled hours fail to conform to a budget and/or is insufficient to meet demand. Due to the constant evolution of forecast customer traffic, forecast sales, and operational schedules (i.e., delivery schedules, planned events), significant resources are expended to build new budgets and labor demand. This leads to the typical causes of a mismatch of budget to demand to workload such as: time segment rounding error, high processing times causing forecast updates, and business reaction to these forecasts to be made more narrowly than desired to match workload to budgets.

### SUMMARY

Some examples provide a system for per-role customized labor demand allocation. The system includes a memory; at least one processor communicatively coupled to the memory; and a data storage device storing a budget plan associated with a selected role in a plurality of roles and historic operational data associated with the selected role. The historic operational data includes transaction data and/or foot traffic patterns within the item selection area. The budget plan includes a plurality of hours allocated to the selected role at a selected location for a selected time-period. A month splitter component analyzes the budget plan and live metric data associated with scheduled operations at the item selection area using a set of per-role configuration criteria and a set of per-role metric weights assigning a percentage weight to each metric in the set of forecast metrics. The month splitter component allocates a set of hours from the plurality of hours to a selected day in a plurality of days based on a result of the analysis. An intra-day splitter component spreads the set of hours across a set of time-segments for the selected day based on a metric spreading routine. A smoothing component performs rounding and smoothing across a user-selected time window to reduce spikes and gaps in the set of hours spread across the user-selected time window while ensuring an exact match with the budget plan.

Other examples provide a computer-implemented method for budget driven labor demand allocation. A budget plan associated with a selected role is retrieved from a data storage device. The budget plan includes a plurality of goal hours allocated to the selected role at a selected location for a selected time-period. A week splitter component analyzes the budget plan and live metric data associated with an item selection area using a set of per-role configuration criteria, historical operational data associated with the selected role and a set of per-role metric weights. A week splitter component allocating a set of hours from a plurality of hours to each week in a set of weeks based on a result of the analysis and the live metric data, including a weekly item delivery schedule for the item selection area. A week splitter component re-splits the set of hours a selected week. The hours for a selected week are re-split back down to a selected day in a plurality of days associated with the selected week. An intra-day splitter component spreads the set of hours across a set of time-segments for the selected day based on a selected forecast spreading routine. A validation component validates the set of per-role allocation hours conforms with the budget plan during a given time-period. An assignment component outputs the set of per-role allocation hours to the selected role on condition the set of per-role allocation hours are validated based on the budget plan.

Still other examples provide a system an intra-day splitter component allocates a set of hours available to a selected role on a selected day across a set of time-segments for the selected day based on a selected forecast spreading routine. The selected forecast spreading routine includes a midpoint spreading routine or an end-points spreading routine. A validation component compares a set of per-role allocation hours with per-role goal hours associated with the budget plan to verify the generated set of per-role allocation hours conforms with the budget plan goal hours during the given time-period. An assignment component assigns the set of per-role allocation hours to the selected role on condition the set of per-role allocation hours are validated based on the budget plan.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for budget-driven labor demand allocation.

FIG. 2 is an exemplary block diagram illustrating an item selection area associated with a plurality of roles.

FIG. 3 is an exemplary block diagram illustrating a labor demand splitter component.

FIG. 4 is an exemplary block diagram illustrating a labor demand splitter component including a week splitter component.

FIG. 5 is an exemplary block diagram illustrating a labor demand splitter component performing coverage-fill and edge-fill.

FIG. 6 is an exemplary block diagram illustrating a database.

FIG. 7 is an exemplary block diagram illustrating a demand generation process.

FIG. 8 is an exemplary block diagram illustrating a demand generation process using live metric data.

FIG. 9 is exemplary block diagram illustrating an intra-day forward spreading routine.

FIG. 10 is exemplary block diagram illustrating an intra-day reverse spreading routine.

FIG. 11 is exemplary block diagram illustrating an intra-day midpoint spreading routine.

FIG. 12 is exemplary block diagram illustrating an intra-day endpoint spreading routine.

FIG. 13 is an exemplary flow chart illustrating operation of the computing device to generate a validated per-role demand allocation.

FIG. 14 is an exemplary flow chart illustrating operation of the computing device to generate a per-role demand allocation using an intra-day forecast spreading routine.

FIG. 15 is an exemplary flow chart illustrating operation of the computing device to generate a validated per-role demand allocation using a midpoint spreading routine.

FIG. 16 is an exemplary flow chart illustrating operation of the computing device to generate a validated per-role demand allocation using an endpoint spreading routine.

FIG. 17 is an exemplary graph illustrating intra-day metric spread of labor over a plurality of time-segments.

FIG. 18 is an exemplary graph illustrating intra-day metric spread rounding.

FIG. 19 is an exemplary graph illustrating intra-day metric spread smoothing.

FIG. 20 is an exemplary graph illustrating intra-day metric spread budget match.

FIG. 21 is an exemplary graph illustrating edge-fill and coverage fill.

FIG. 22 is an exemplary table illustrating rounding values and rounding threshold.

FIG. 23 is an exemplary table illustrating budget-driven labor demand allocation.

Corresponding reference characters indicate corresponding parts throughout the drawings.

### DETAILED DESCRIPTION

Referring to the figures, examples of the disclosure enable a system for allocating budget-driven labor demand customized on a per-role and/or per-location basis. In some examples, a labor demand splitter is provided which matches labor demand allocation to a budget based on live metrics, seasonal demand, event-driven metrics, edge-filling allocated time segments, coverage fill, offsetting, and user-defined forecast spreading routines for intra-day splitting of demand hours during a given month while ensuring the allocated hours conform to goal hours assigned to a given role by the budget plan. This enables more accurate and reliable allocation of hours to roles while adhering to budget constraints for each role.

In other examples, the labor demand splitter provides a simple, repeatable, sustainable budget driven demand generation process that is reliable, validates with a budget, delivers accurate demand, and minimizes human error in demand generation. The labor demand splitter provides data validation that catches mismatch to budget while accommodating holidays and events. In still other examples, a demand reloading process corrects demand issues to generate a per-role demand allocation that is reliable and minimizing human error.

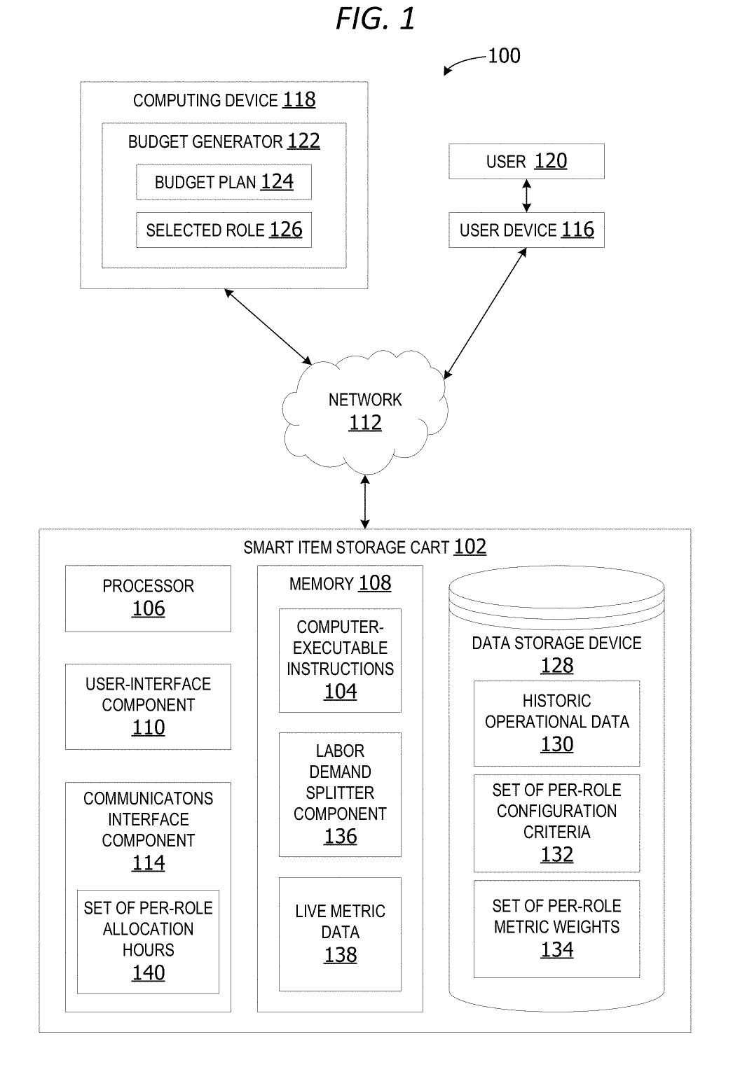

Referring again to FIG. 1, an exemplary block diagram illustrates a system 100 for budget-driven labor demand allocation. In the example of FIG. 1, the computing device 102 represents any device executing computer-executable instructions 104 (e.g., as application programs, operating system functionality, or both) to implement the operations and functionality associated with the computing device 102. The computing device 102 can include a mobile computing device or any other portable device. In some examples, the mobile computing device includes a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 can also include a user interface component 110.

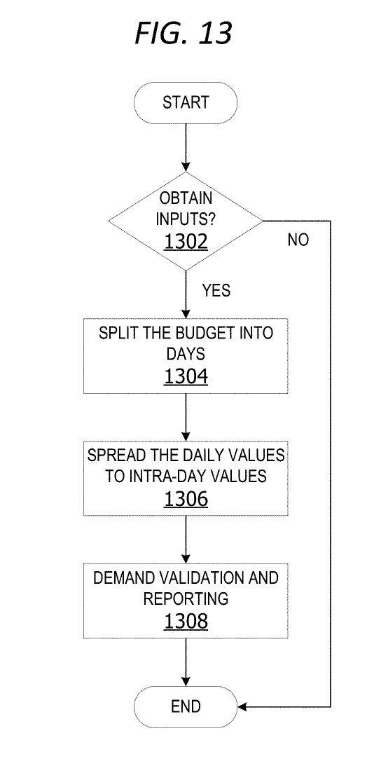

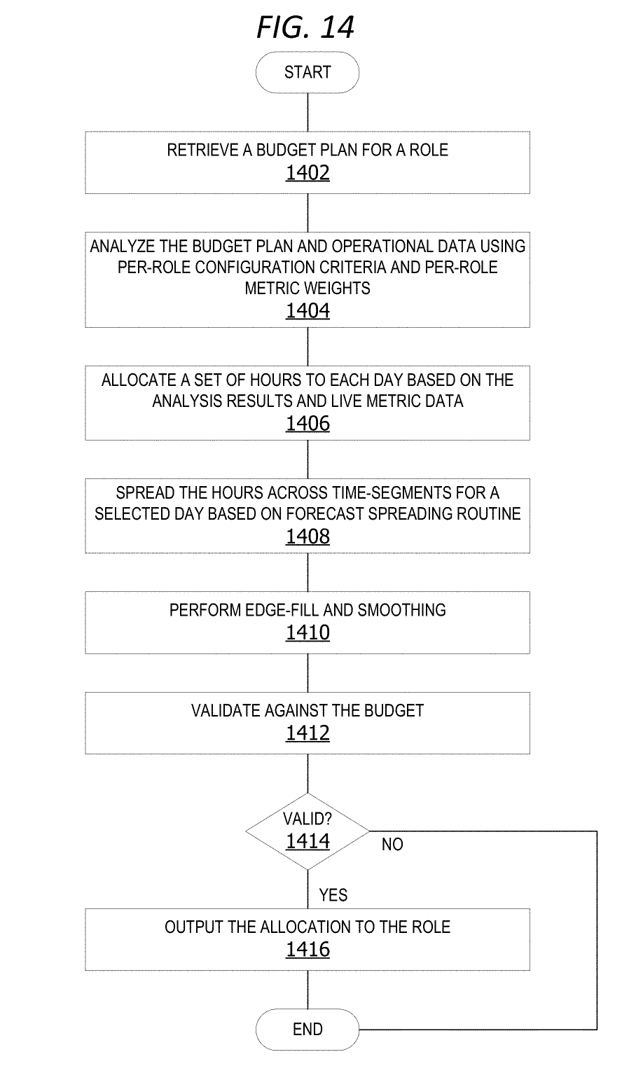

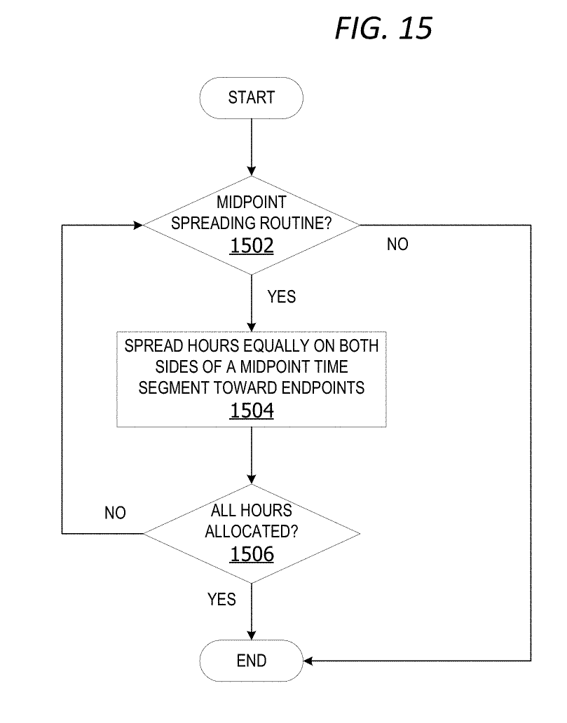

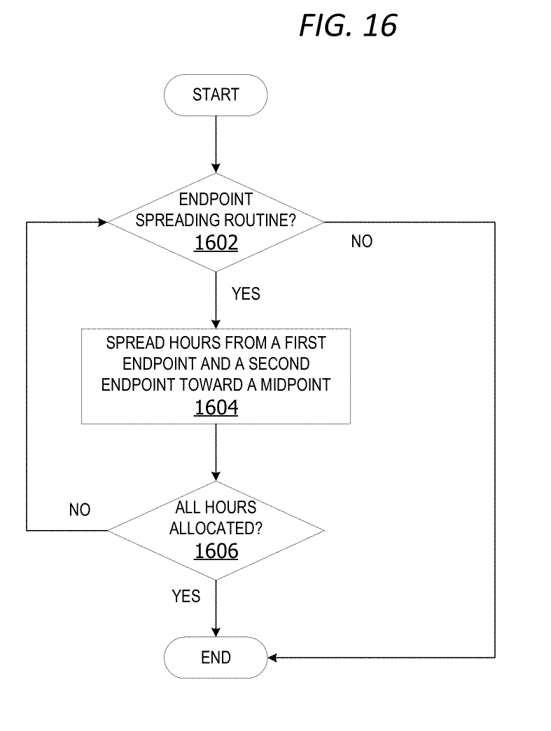

The processor 106 includes any quantity of processing units and is programmed to execute the computer-executable instructions 104. The computer-executable instructions 104 can be performed by the processor 106 or by multiple processors within the computing device 102 or performed by a processor external to the computing device 102. In some examples, the processor 106 is programmed to execute instructions such as those illustrated in the figures (e.g., FIG. 13, FIG. 14, FIG. 15 and FIG. 16).

The computing device 102 further has one or more computer-readable media such as the memory 108. The memory 108 includes any quantity of media associated with or accessible by the computing device 102. The memory 108 can be internal to the computing device 102 (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. For example, the applications can represent downloaded client-side applications that correspond to server-side services executing in a cloud.

In other examples, the user interface component 110 includes a graphics card for displaying data to the user and receiving data from the user. The user interface component 110 can also include computer-executable instructions (e.g., a driver) for operating the graphics card. Further, the user interface component 110 can include a display (e.g., a touch screen display or natural user interface) and/or computer-executable instructions (e.g., a driver) for operating the display. The user interface component 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. For example, the user can input commands or manipulate data by moving the computing device 102 in one or more ways.

The network 112 is implemented by one or more physical network components, such as, but without limitation, routers, switches, network interface cards (NICs), and other network devices. The network 112 can be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to a user device 116 and/or a remote computing device 118, can occur using any protocol or mechanism over any wired or wireless connection. In some examples, the communications interface component 114 is operable with short range communication technologies such as by using near-field communication (NFC) tags.

The user device 116 represent any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface component for outputting data to a user 120 and/or receiving data from the user 120.

The remote computing device 118 represents any device executing computer-executable instructions (e.g., as application programs, operating system functionality, or both) to implement the operations and functionality associated with the computing device 118. The computing device 118 can include a mobile computing device or a less portable device, such as a server, desktop personal computer, kiosk, or tabletop device. In some examples the computing device 118 can represent a cloud server. The computing device 118 includes a processor and a memory. Additionally, the computing device 118 can represent a group of processing units or other computing devices.

In some examples, the computing device 118 executes a budget generator 122 for generating a budget plan 124 associated with a selected role 126. The budget plan 124 is a labor budget for running a store or other facility for a month. The budget plan 124 is the labor budget for a selected role. The role can include any task/duty or set of tasks assigned to a user in an item selection area.

An item selection area is a location storing or displaying a plurality of items. An item selection area can include a store, a warehouse, a distribution center, or any retail environment. In some non-limiting examples, the item selection area includes a grocery store, a hardware store, a pet supply store, an automotive parts store, or any other type of store. In still other non-limiting examples, an item selection area is an area or department within a store. In these examples, a single store can include multiple different item selection areas. For example, an item selection area in a store can include, without limitation, a grocery area, an office supply area, an electronics department, a pet supply department, an automotive parts department, a clothing department, a shoe department, a baby supplies department, a toy department, etc. In still other examples, an item selection area includes areas within a store department. For example, an item selection area can include, without limitation, a produce department, a dairy department, a frozen foods department, a bakery, a meat department, etc.

A role is job, position, title, or other personal designation associated with one or more tasks. A role can include, for example, but without limitation, a cashier, a maintenance personnel, a stock clerk, dock worker, picker, driver, etc.

The system 100 can optionally include a data storage device 128 for storing data, such as, but not limited to historic operational data 130, a set of per-role configuration criteria 132 and/or a set of per-role metric weights 134. The historic operational data 130 includes operational metrics associated with a selected location. The historic operational data 130 is data describing operations at a store or other retail environment associated with a past time or a previous time-period. The historic operational data 130 can include historic foot traffic in a store, past transactions/sales (historic transaction data), previous item shipments to the store (truck deliveries), operating hours, etc. Transaction data can include data associated with one or more transactions, such as, but not limited to, item purchases, item returns, or any other transactions.

The set of per-role configuration criteria 132 in some examples defines all the roles split by month, by week, by day and/or by intra-day split. The set of per-role configuration criteria 132 also defines how each role is split. The set of per-role configuration criteria 132 includes a set of one or more rules for calculating allocation of hours customized for a specific role. A per-week role configuration specifies how a week to day split is handled. A per-day role configuration criterion specifies how a day to intra-day spread is handled. An intra-day spread refers to spreading hours over item-segments, such as, but not limited to, how a day to quarter-hour spread is handled. In some examples, the set of per-role configuration criteria 132 can specify that cashiers receive more hours on weekends than on weekdays and/or that cashiers receive more hours in the evening (after five o'clock) than in the mornings.

The set of per-role metric weights 134 indicates a weight to be assigned to each metric customized for each role. A per-week metric weight maps metric groups to roles and specifies split weightings. A per-day metric weight maps some metric groups to roles and specifies split weightings. The set of per-role metric weights 134 defines how metrics should be weighted for splitting up budget data for month splits, week splits, day splits, and/or intra-day splits customized for a selected role.

In some examples, the set of per-role metric weights 134 specifies that foot traffic metrics be given greater weight than truck delivery metrics for a cashier role. Likewise, the set of per-role metric weights 134 can specify that truck delivery schedules be given greater weight than transaction metrics for a stock clerk/dock worker tasked with unloading pallets from delivery trucks.

The data storage device 128 can include one or more different types of data storage devices, such as, for example, one or more rotating disks drives, one or more solid state drives (SSDs), and/or any other type of data storage device. The data storage device 128 in some non-limiting examples includes a redundant array of independent disks (RAID) array. In other examples, the data storage device 128 includes a database.

The data storage device 128 in this example is included within the computing device 102 or associated with the computing device 102. In other examples, the data storage device 128 is a remote data storage accessed by the computing device via the network 112, such as a remote data storage device, a data storage in a remote data center, or a cloud storage.

The memory 108 in some examples stores one or more computer-executable components. Exemplary components include a labor demand splitter component 136. The labor demand splitter component 136, when executed by the processor 106 of the computing device 102, analyzes the budget plan 124 and live metric data 138 using the set of per-role configuration criteria 132 and the set of per-role metric weights 134 to generate a per-role allocation of hours. In some examples, the labor demand splitter component 136 spreads and divides the budget plan for the selected role among all the different shifts throughout the day and all the correct job codes such that the daily allocation of hours to each role exactly matches the budget.

The live metric data 138 includes current operational metrics for a coming week. In some examples, the set of live metric data 138 includes a weekly truck delivery scheduled, predicted foot traffic for each day of the week, predicted transactions/demand, etc.

The labor demand splitter component 136 allocates a set of one or more hours to a selected role on a selected day across a set of time-segments for the selected day based on a selected forecast spreading routine. The labor demand splitter component 136 compares the set of per-role allocation hours with the budget plan 124 to verify the generated set of per-role allocation hours conforms with goal hours provided by the budget plan during the given time-period. If the set of per-role allocation hours 140 are validated based on the budget plan 124, the labor demand splitter component 136 outputs the set of per-role allocation hours 140 to the user 120. The set of per-role allocation hours 140 can be output via the user interface component 110. In other examples, the communications interface component 114 transmits the set of per-role allocation hours 140 to the user device 116 and/or the remote computing device 118.

In some examples, the labor demand splitter component 136 utilizes the per-role configuration criteria and weights to spread a budget (weekly, monthly, daily) equally across a selected time span. The labor demand splitter component 136 begins by breaking a budget approved for a given role during a selected month down to a day. The labor demand splitter component 136 re-splits the daily budget and spreads the daily hours across user-selected time windows as desired. The labor demand splitter component 136 optionally adjusts for specific roles.

The set of per-role configuration criteria 132 in this example includes criteria for spreading hours associated with a selected role. In other examples, the set of per-role configuration criteria 132 includes per-location (store-specific) configuration criteria for spreading budgeted hours customized to a selected store and a selected role at that store. In other words, the set of per-role configuration criteria 132 for a selected role can differ from one store to another store.

For example, a cashier's spread methodology can be based on the number of item scans at a register or the number of transactions at a register. Forty-percent of the cashier role is labor, and sixty-percent of the labor is tendering payment at the register. If the cashier has one-hundred hours, the labor demand splitter component 136 splits the hours across each day based on daily predicted customer foot traffic patterns and/or the number of transactions for the selected store.

In another example, if an overnight stocker has one-hundred hours, the labor demand splitter component 136 spreads the one-hundred hours across days in a week or days in a month based on truck delivery schedules. In one example, the labor demand splitter component 136 generates a demand spread across fifteen-minute time-segments.

The labor demand splitter component 136 splits the hours to each day. The labor demand splitter component 136 allocates hours within the day. The labor demand splitter component 136 utilizes a targeted budget number (goal hours) for each day of the week based on the historic operational data 130. In some non-limiting examples, the labor demand splitter component 136 utilizes six weeks of historic data by time of day to allocated hours budgeted for the day by fifteen-minute time-segments. The labor demand splitter component 136 verifies the number of hours allocated for each day match up to the number of hours budgeted for each day.

Demand for a given role can vary throughout a single day. Therefore, the system allocates demand within each day (intra-day split) based on demand during a predetermined time-interval. In some non-limiting examples, the time-interval is a fifteen-minute interval. In other examples, the time-interval is a ten-minute interval, a twenty-minute interval, a thirty-minute interval, or any other user-configured time-period.

The intra-day splitter in some examples takes a daily labor budget for a given role and spreads it over the day in the predetermined time-interval increments. If the daily budget for a cashier role is twenty-hours and the time-interval is fifteen minutes, the system spreads the twenty-hours across the day in fifteen-minute portions of the day to create a curve. The intra-day splitting can create fractions of a full-time equivalent (FTE). For example, if the intra-day split creates an allocation of 2.3 people at two o'clock, the system rounds the number down to 2.0 or up to 3.0, depending on the rounding value, the number of hours remaining for allocation and the daily budget constraints. A rounding algorithm ensure we have allocations of whole persons without fractions.

The labor demand splitter component 136 uses edge filling and smoothing to add or reduce hours to ensure the aggregate shape/hours in fifteen-minute time-segments add to the total daily number budgeted after rounding. In one example, the labor demand splitter component 136 takes a percentage value allocated for each time-period and multiplies that value by the budget number and rounding. The labor demand splitter component 136 rounds values for fractions of people up or down to achieve whole numbers of people for each role at each time-segment. The number of people allocated for each role does not add up to the budgeted number due to rounding up of some fractional values at each 15-minute time-interval. The labor demand splitter component 136 determines which remainder number of hours are available after rounding is applied. The labor demand splitter component 136 determines if there are sufficient hours to add to another time segment so output matches desired goal hours for that specific day of the week. The labor demand splitter component 136 can utilize edge-filling to ensure the allocated hours match the budget for each day.

In other examples, the labor demand splitter component 136 utilizes role rounding for roles that require a fixed number of hours per shift or per day. For example, if the budget for a role in a week is not exactly rounded to fifteen-minutes or if the role requires a fixed eight-hours (full-time only) per shift. The role rounding rounds the time out to eight-hour shifts, which can result in remainders less than eight hours. In such cases, the remainders can be allocated to the same role on a different day of the week or the remainder can be allocated to a different role. If the remainder is allocated to a different role, the remainder can be applied to the same day or another day during the same week. In one example, if the budget provides thirty-four hours to a night-shift stocker role that requires a fixed eight-hour shift, the system allocates thirty-two hours (four eight-hour shifts) with a two-hour remainder. The two-hour remainder can be added to the allocation for this role on another day or added to an allocation for another role. For example, the two-hours can be given to a different day-time stocker role in the morning shift.

In other examples, the labor demand splitter component 136 performs task-level demand generation. The labor demand splitter component 136 receives raw demand and a list of individual tasks with demand effective times as input with a spread method. The spread method can include forward-fill, reverse-fill, curve-shape, even-fill, midpoint-fill or endpoint-fill. The labor demand splitter component 136 applies the spread shape to the raw demand per task. The labor demand splitter component 136 aggregates the time segment demand for total role and rounds the demand down by time segment. The labor demand splitter component 136 then prioritizes which demand time segments get added back to “true up” back to the raw demand value for the role. This is essentially the same as role-spreading and rounding for cashier but done at task-level vs. role-level. It can result in significantly more true demand shapes for the role, based on the realistic nature of the work being done in the store.

The outputs of the task-level demand generation is compiled from multiple task segments. In some examples, to support task-based demand, a task-file generator is created. This generates the input which is composed of input and output. The input includes configuration of each task. The configuration includes default effective times, spread methods and/or role. The input can also include task-based demand by date. The output, in some examples, includes demand date, task name, role, effective time, spread method and/or raw demand value.

The store-specific effective times input can include a list for stores, roles, tasks and/or their override effective times. The output is used by the labor demand splitter component 136 to account for customer effective times for stores.

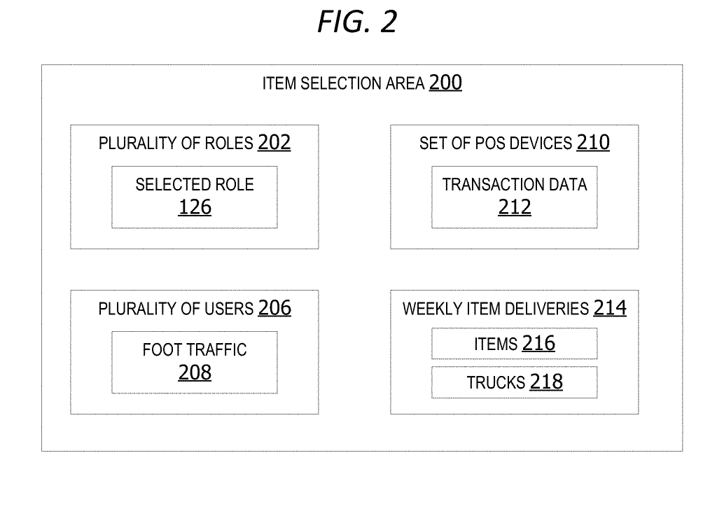

FIG. 2 is an exemplary block diagram illustrating an item selection area 200 associated with a plurality of roles 202. The item selection area 200 is a location including a plurality of roles. The item selection area 200 can include a retail store, a warehouse, a distribution center, or any other retail location. The item selection area 200 can include an interior location, an exterior location, as well as a combination of interior and exterior spaces.

The plurality of roles 202 includes roles associated with jobs and/or tasks within the item selection area 200. The plurality of roles includes two or more roles, such as, but not limited to, the selected role 126/The plurality of roles 202 can include, for example and without limitation, a truck driver, a picker/pallet builder, stock clerk, cashier, quality control personnel, maintenance personnel, mechanic, pallet fork driver, garden center personnel, etc. The labor demand splitter component generates an allocation of hours customized for a selected role 126 at the item selection area 200.

A plurality of users 206 visit the item selection area 200. The number of users within the item selection area 200 at any given time is the foot traffic 208. The foot traffic 208 can vary based on the day of the week, time-of-day, season, holidays and/or events.

A set of one or more point-of-sale (POS) devices 210 generate transaction data 212 associated with the sales and returns of one or more item(s) 216. Weekly item deliveries 214 includes one or more truck(s) 218 delivering one or more item(s) 216, including cases and/or pallets of items, to the item selection area 200 within a predetermined time-period. The predetermined time-period can include any amount of time, such as, without limitation, a per-day time-period, a weekly time-period, a monthly time-period, an annual time-period. In this example, the weekly item deliveries 214 includes scheduled deliveries expected to arrive during a future week.

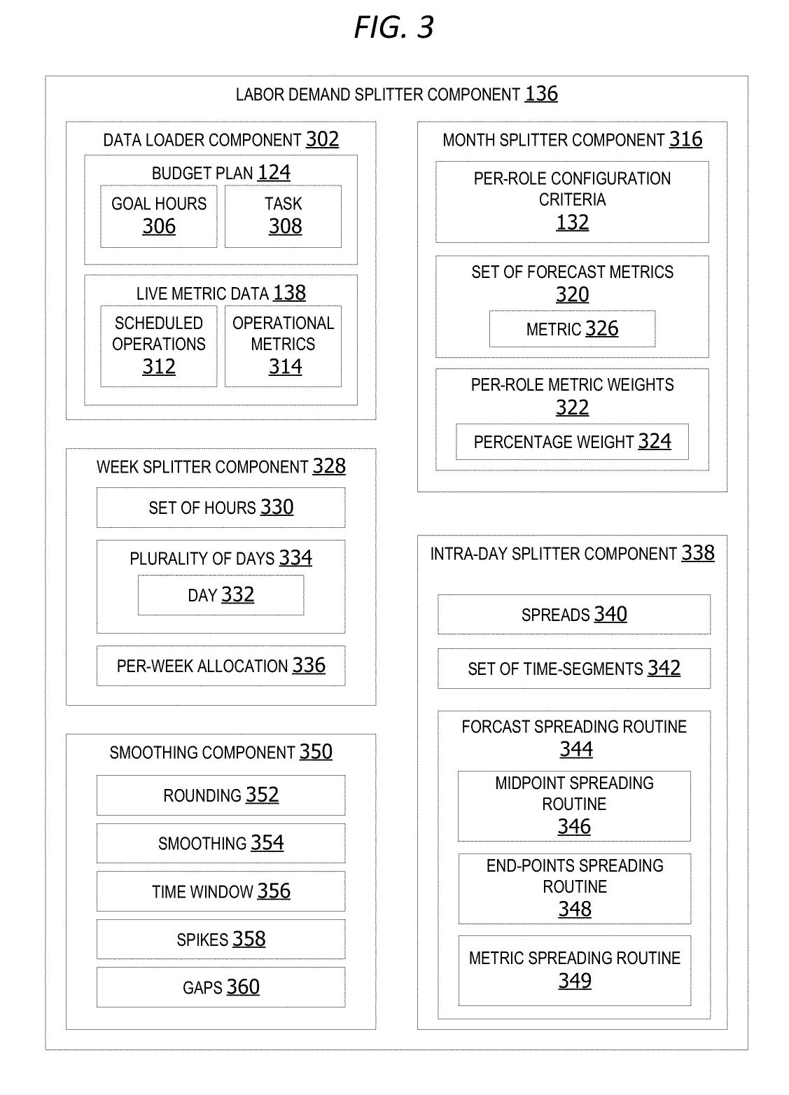

FIG. 3 is an exemplary block diagram illustrating a labor demand splitter component 136. A data loader component 302 obtains a budget plan 124 associated with a selected role from a budget generator, such as, but not limited to, the budget generator 122 in FIG. 1. The budget plan 124 includes per-role goal hours 306 associated with one or more tasks 308 assigned to the selected role. The goal hours 306 are allocated to a selected role at a selected location for a selected time-period.

The data loader component 302 also obtains live metric data 138 associated with scheduled operations 312 at the item selection area. The live metric data 138 includes operational metrics 314, such as, but not limited to, upcoming delivery schedules, updated traffic patterns associated with the item selection area, and other operational metrics associated with a future time-period.

The data loader component 302 can use high-level aggregation (bottom up or top down) to obtain data without having to calculate granular demand at fifteen-minute intervals. This allows the financial labor planning cycle to iterate very quickly without waiting on systems to process fifteen-minute level data.

In this example, the data loader component 302 is a single data loader that obtains the budget plan(s), live metric data, operational data, historic data, and any other associated data utilized during the allocations. In other examples, the data loader component is implemented as a first data loader that loads the budget plan from a file, file system, database, data storage, or other data source. A second data loader separate from the first data loader obtains/loads the live metric data, operational data, historic data, and other data utilized during the labor demand allocation operations.

A month splitter component 316 analyzes the budget plan 124 and the live metric data 138 using a set of per-role configuration criteria 132 and a set of forecast metrics 320 associated with the selected role. The set of forecast metrics 320 includes one or more metrics used to predict labor demand associated with a selected role during a selected future time-period. The metrics can include predicted foot traffic, scheduled/expected item deliveries to a given location, predicted transactions, etc. Per-role metric weights 322 includes a percentage weight 324 assigned to each metric 326. The metric weights can include, without limitation, one or more weights in set of per-role metric weights 134 in FIG. 1. In some examples, month splitter purge rules prevent wiping out all previous plan splits when splitting a new month.

In some examples, the month splitter component 316 analyzes a budget plan for a role to determine the number of hours allocated in the budget to that role for the month. For example, if the selected role is a cashier and the budget provide two-thousand hours for the cashier in the month of January. The month splitter component 316 splits the two-thousand hours by each week and each day of the week in month of January. The month splitter component 316 aligns the two-thousand hours (allocates the hours to each day) based on predicted demand for those days. In other words, if the number of cashier transactions is expected to be higher on the weekends than on the weekdays, the month splitter component 316 assigns more hours to weekends and fewer hours to the weekdays. This is the month split process determining the number of hours for a role expected to be required/spent each day of the week. Those daily hours (hours per each week/each day of the week), in aggregate, equal the original two-thousand hours in the budget plan for the selected cashier role.

A week splitter component 328 allocates a set of one or more hours 330 from the plurality of hours to a per-week allocation 336. The week splitter component 328 then splits the per-week allocation 336 of labor demand down to a per-day split. In other words, the week splitter component 328 analyzes the per-role budget plan 124 and live metric data 138 to create a weekly allocation of hours. The weekly allocation of hours is then re-split into a daily allocation of hours to product an allocation of hours for each day 332 in the plurality of days 334. The allocation 336 is performed based on a result of the analysis of the budget plan 124, per-role configuration criteria, criteria weights, and the live metric data 138.

An intra-day splitter component 338 spreads 340 the daily values to intra-day values. In this example, the intra-day splitter component 338 spreads the set of hours 330 for the selected day 332 across a set of one or more time-segments 342 for the selected day 332 based on a selected forecast spreading routine 344. The selected forecast spreading routine 344 includes a midpoint spreading routine 346, an end-points spreading routine 348 and/or a metric spreading routine 349. Other spreading routines include forward spreading and backward spreading. The intra-day splitter component 338 can also perform metric-based spreading and/or spreading in accordance with user-defined shapes.

In some examples, the week splitter component and/or the intra-day splitter component 338 performs rounding and smoothing to ensure an exact match between the allocated hours and the daily budget. The intra-day splitter component 338 can re-combine tasks into a single role.

The midpoint spreading routing 346 spread hours in a first set of hours beginning at a user-configurable mid-point time segment allocating hours equally on both sides of the user-configurable mid-point time segment. The hours are spread away from the mid-point time segment toward a first end-point and a second end-point until all hours in the first set of hours are allocated.

The end-points spreading routine 348 spreads hours in a first set of hours from a user-configurable first end-point and a user-configurable second end-point equally toward a mid-point until all hours in the first set of hours are allocated.

A smoothing component 350 performs rounding 352 and smoothing 354 across a user-selected time window 356 to reduce spikes 358 and gaps 360 in the set of hours 330 spread across the user-selected time window 356 while ensuring an exact match with the budget plan 124.

In one non-limiting example, the labor demand splitter component 136 spreads a monthly budget or a weekly budget down to a daily level. The labor demand splitter component 136 utilizes an algorithm selected based on the per-role configuration settings, metric data and the amount of fixed work. The labor demand splitter component 136 spreads the hours equally across the days of the week or month. The labor demand splitter component 136 spreads the daily values across the day (intra-day split) to make sure the workload is appropriately allocated.

Some roles require minimum coverage. For example, a maintenance role can require a minimum coverage of three-hours every morning for routine cleaning/maintenance tasks which are performed daily regardless of foot traffic or other metrics. In such cases, the labor demand splitter component 136 allocates the minimum coverage hours for each day and subtracts the minimum coverage hours from the budgeted hours for each day before splitting and spreading. The labor demand splitter component 136 performs splitting and intra-day spreading of the remaining hours based on variable metrics associated with the role. Intra-day spreading/splitting for a role can be performed on a fixed, variable or fixed shape basis in some examples.

In one example, the per-role configuration criteria define any fixed minimums for the role. For example, the per-role configuration can specify a role receive a minimum of eight hours for every day in a week. In another example, the minimums configuration for a role can specify a minimum of sixteen-hours on weekends (Friday, Saturday and Sunday) with no minimums for weekdays (Monday, Tuesday, Wednesday and Thursday). The minimums ensure sufficient hours for routine tasks and/or minimum role coverage. If the budget does not accommodate the minimum, the system outputs an error.

In one example, the labor demand splitter component 136 subtracts the minimum hours from the weekly budget hours to spread over the defined minimum without going below zero. The labor demand splitter component 136 can optionally spread hours over a fixed-shape minimum metric if there are insufficient budget hours to cover the minimums. The labor demand splitter component 136 spreads the remaining budget hours over the variable metrics defined in the per-role configuration criteria. The fixed minimum hours allocation and the remainder variable metrics-based allocations are added back together to generate a final per-role demand allocation spread.

In an exemplary scenario, if a role has twenty-hours for a single day and the operating hours for that role is between eight in the morning (8:00 a.m.) and ten in the evening (10:00 p.m.), the labor demand splitter component 136 determines where to allocate the daily value of twenty hours across the possible fourteen operational hours. This can entail determining where to put those hours within the day, how many people in the role throughout the day, etc. The labor demand splitter component 136 can determine minimum coverage times, medium coverage, and maximum coverage times throughout the day based on foot traffic patterns, numbers of items sold (transactions), delivery schedules, or other live metric data and historic operational data. Minimum coverage can refer to a single person serving in a role or no persons serving in the role. Maximum coverage can refer to two or more persons serving in the role at any given time-period during the day.

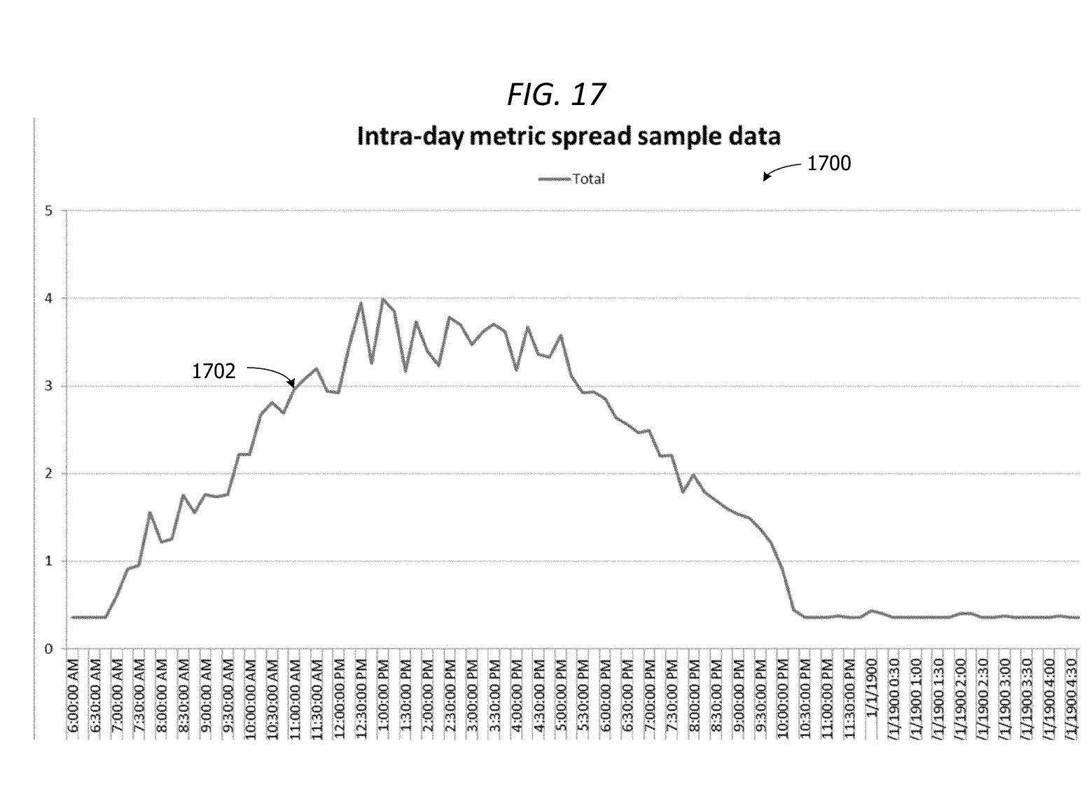

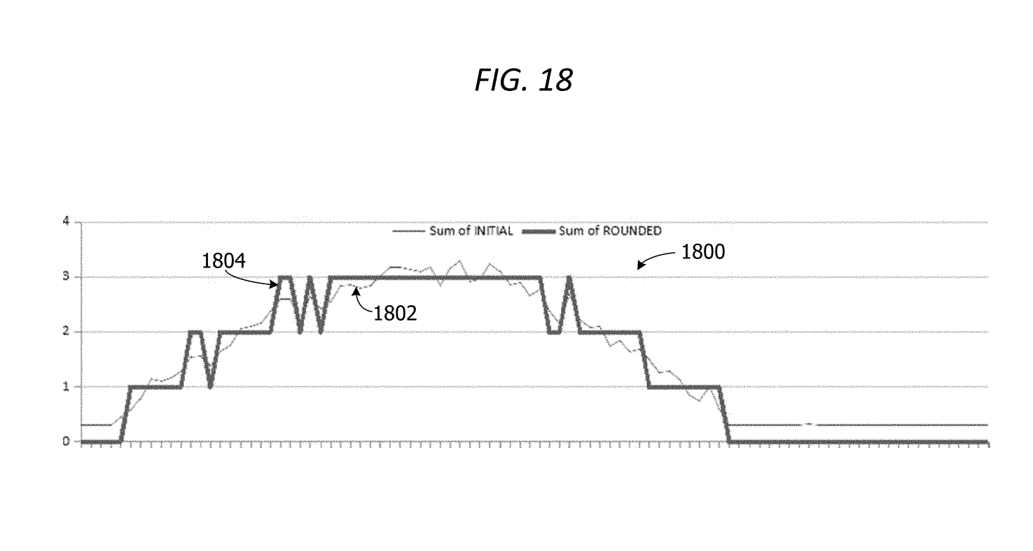

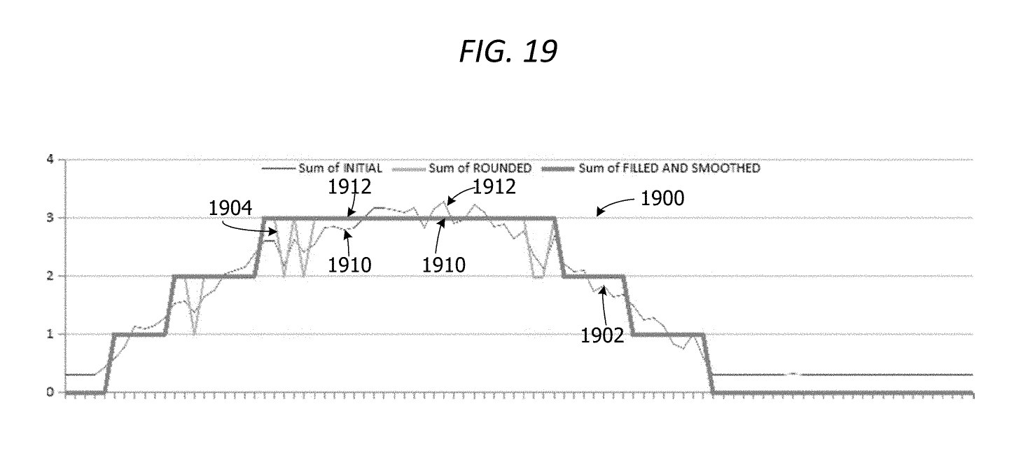

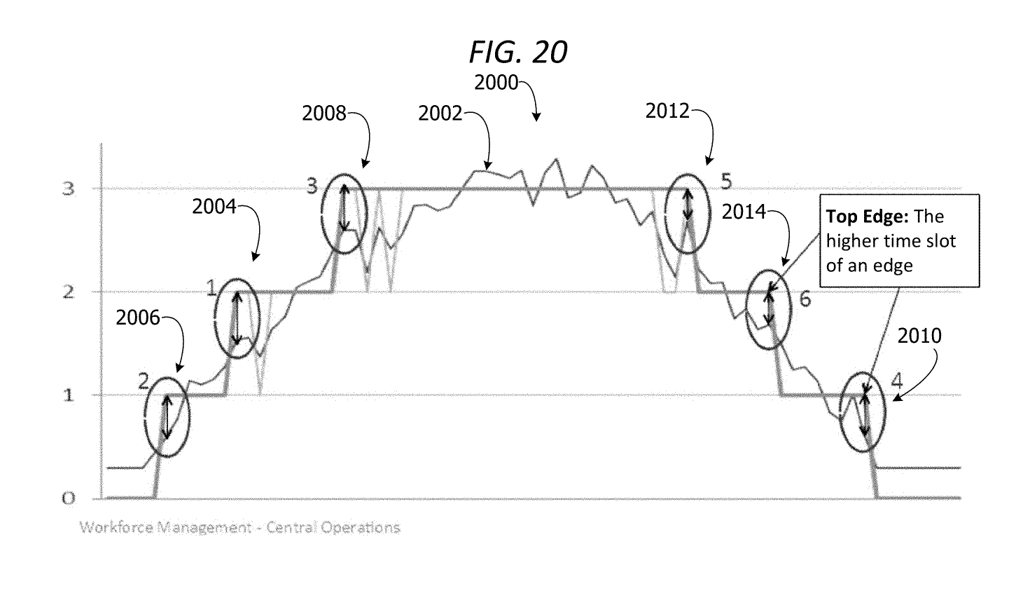

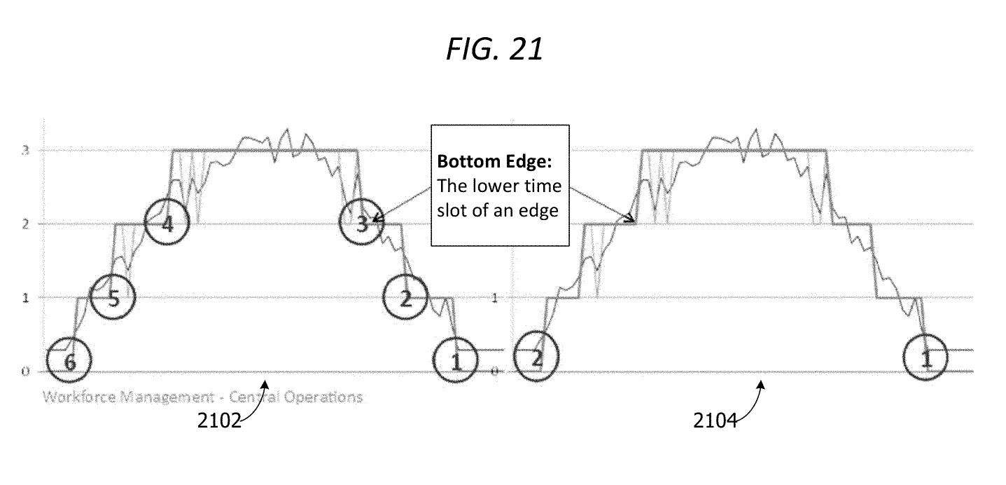

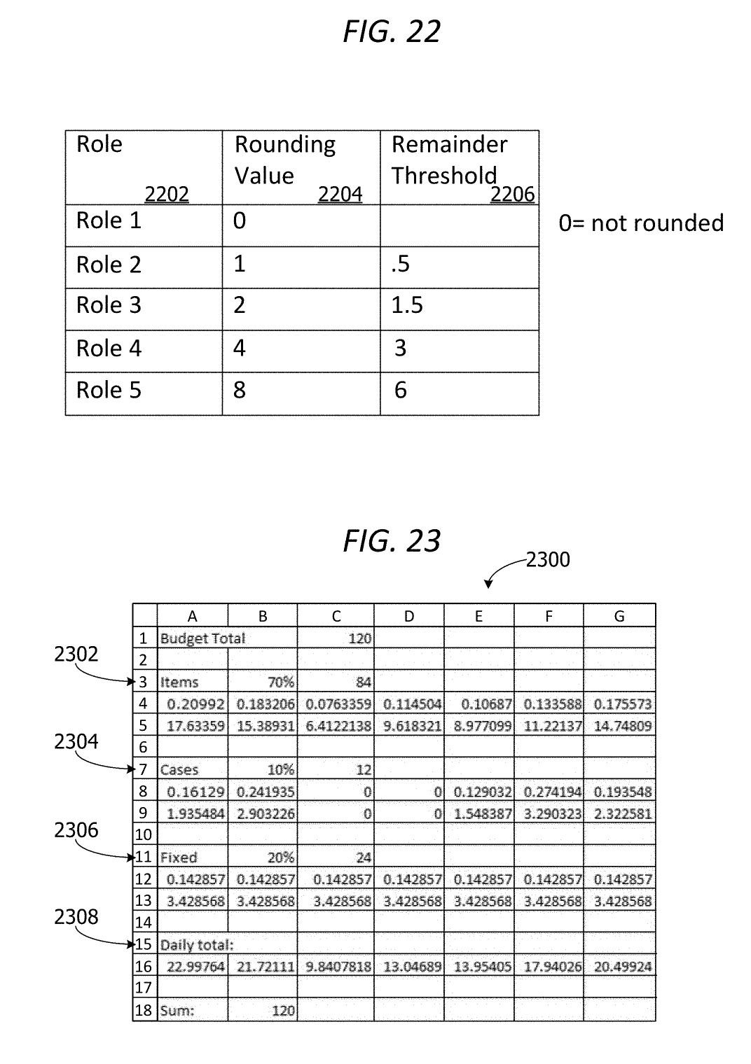

The spread of hours during the day creates a pattern. If there are no users or only a single user (minimum coverage) for a given time-period, the shape of the spread during that time is flat. If the number of persons/coverage varies gradually over time, the shape can be a bell-curve. Examples of graphs illustrating processes for demand allocation associated with a role having variable demand in accordance with some examples are shown below in FIG. 17, FIG. 18, FIG. 19, FIG. 20, FIG. 21, FIG. 22 and FIG. 23.

In some examples, if a role is associated with routines that do not vary based on live metric data, such as roles that do not involve customer interaction, the demand is flat across the day. Routines that involve customer interactions can increase and decrease across the day due to changing customer traffic, customer interactions, delivery schedules, etc. If a role includes twenty-percent customer interactions and eighty-percent routine work, the labor demand splitter component 136 identifies a spreading method (several spreading algorithms) that considers both the live metrics/variable demand as well as the fixed demand.

The labor demand splitter component 136 includes customized seasonal metrics. Seasonal metrics can be specified for one or many days in the week. The seasonal metrics can specify if it is a multiplier or a replacement of the original data. If seasonal data for the selected store is not available, the labor demand splitter component 136 can utilizes seasonal data from other similar stores (like-store data).

Some roles can include a fixed-value task applied to a specific event in a month. For example, if a role includes performing a cost inventory task that takes seven hours to perform on the last Tuesday of each month, the inventory task is a fixed-event. The labor demand splitter component 136 applies the minimum/fixed-value allocated to the fixed event. The fixed-value/minimum is subtracted from the budget for that role. The labor demand splitter component 136 performs splitting and spreading using variable metrics on the remaining hours. In other words, the labor demand splitter component 136 spreads the remaining hours as defined in the variable with minimum solution or fixed shape solution.

In other examples, the intra-day splitter component 338 has the ability to creates tasks. If there is a cashier role, that role can be spread by a metric, even, reverse or mid-point spread. The shape is specified by the algorithm. The intra-day splitter component 338 can take the composite of any of those spreading mechanisms split up into multiple tasks or task groups. The intra-day splitter component 338 can create morning routines, evening routines, opening a register, closing a register, etc. Thus, the tasks for a cashier role in one example can include one or more of the tasks performed by a given role through the day for intra-day splitting.

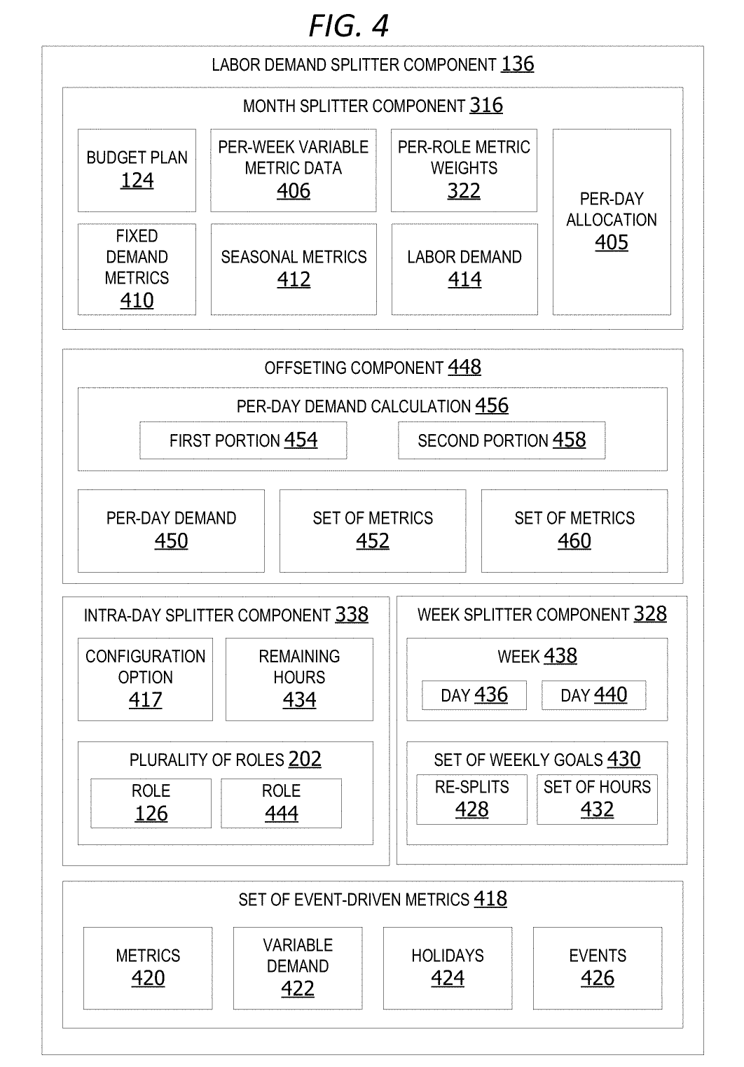

FIG. 4 is an exemplary block diagram illustrating a labor demand splitter component 136 including a month splitter component 316. The month splitter component 316 splits the hours allocated to a selected role 126 for a given month into each day of the month. A given day in the month can receive no hours, four hours, six hours, eight hours, ten hours, fifteen hours, twenty-four hours, or any other number of hours.

In some examples, the month splitter component 316 analyzing the budget plan 124 and per-week variable metric data 406 associated with the at least one task using one or more per-role metric weights 322 associated with the selected role. The one or more per-role metric weights 322 includes a percentage weight assigned to each forecast metric.

In some non-limiting examples, the month splitter component 316 or the week splitter component 328 performs the per-day allocation 405 based on a fixed labor demand 414 task associated with the selected day in accordance with fixed demand metrics 410. The week splitter component 328 in other examples allocates the set of hours to each day in the plurality of days based on the seasonal metrics 412. In other examples, the month splitter component 316 allocates hours to each day in a month based on an analysis of the live metric data using a set of event-driven metrics 418.

The labor demand splitter component 136 can include a week splitter component 328. In some examples, the week splitter component 328 performs a per-week allocation. The week splitter component 328 performs a per-week allocation that splits/assigns the hours allocated to the selected role 126 for a given month into each week in the month. The week splitter component 328 then re-splits the per-week allocation of hours for a selected week 438 to a per-day allocation. The per-day allocation splits the weekly allocation down to a daily allocation of hours by assigning a subset of hours to each day in the week. In this example, the week splitter component 328 allocates hours to a day 436 and a day 440 in a given week. The week splitter component 328 can allocate no hours, a single hour, six hours, fifteen hours, or any other number of hours.

In this example, the week splitter component 328 re-splits 428 hours allocated to the selected role based on a set of weekly goals 430 for the selected role, the live metric data and a set of event-driven metrics 418. The set of event-driven metrics 418 includes metrics 420 associated with variable demand 422 during holidays 424 and local events 426 associated with the item selection area.

An offsetting component 448 calculates per-day demand 450 based on a first set of metrics 452 during a first portion 454 of a per-day demand calculation 456. The offsetting component 448 utilizes a second set of metrics 460 for a second portion 458 of the per-day demand calculation 456. In this manner, the offsetting component 448 calculates a per-day demand associated with the selected role and the item selection area based on multiple sets of metrics.

Offsetting is utilized to calculate labor demand using accurate forecasts at the aggregate level without concern for where those metrics were sourced from time of day/day of week stand point. The system remaps/derives value of labor from potentially different metrics than used to schedule metrics—like a two-step process.

In one non-limiting example, if twenty-percent of a role (20% of work) is based on customer interactions and eighty-percent is based on routine tasks, which do not vary, the offsetting component 448 can utilize offsetting to spread budgeted labor across a day based on the twenty to eighty (20-80) metric split.

An intra-day splitter component 338 allocates the set of hours 432 for a given day to one or more-time segments within each day based on the rounding value and the rounding threshold. The rounding threshold rounds labor demand during a week-to-day (re-split) allocation in accordance with a predetermined threshold time segment.

An intra-day splitter component 338 in other examples utilizes a configuration option 417 to reallocate remaining hours 434 available in the budget plan which has not yet been allocated to a given time-segment. In one example, the intra-day splitter component 338 re-allocates all remaining hours 434 due to rounding to the selected role from a first day 436 of the week to a second day 440 (different day) of the same week 438. The month splitter component 316 and/or the week splitter component 328 in other examples re-allocates all remaining hours 434 from the selected role 126 to a different role 444 (second selected role) in the plurality of roles 202. In other examples, the week splitter component 328 performs the rounding based on the rounding threshold and/or a rounding value.

In this example, the labor demand splitter component 136 includes a month splitter component 316, a week splitter component 328 and an intra-day splitter component 338. In other examples, the labor demand splitter component 136 includes a month splitter component 316 and an intra-day splitter component 338 without a week splitter component 328. In yet another example, the labor demand splitter component 136 includes a week splitter component 328 and an intra-day splitter component 338 without a month splitter component 316. In still other examples, the labor demand splitter component 136 only includes the intra-day splitter component 338 without a month splitter component 316 or a week splitter component 328.

During spreading and smoothing, the system can apply various spreading algorithms within the day based on tasks. For example, mid-point spread can be applied for one or more tasks performed during a given time-period. A customer demand curve driven off a metric can be applied to other tasks. Likewise, an even spread can be applied to evenly spread hours for a stocking task. Rounding is performed after the composite is created rather than having the entire day follow one algorithm. In other words, the system can use multiple different algorithms for applying, spreading and/or smoothing hours across tasks associated with each role rather than being limited to a single spreading/smoothing algorithm. This permits a more complex shape during smoothing.

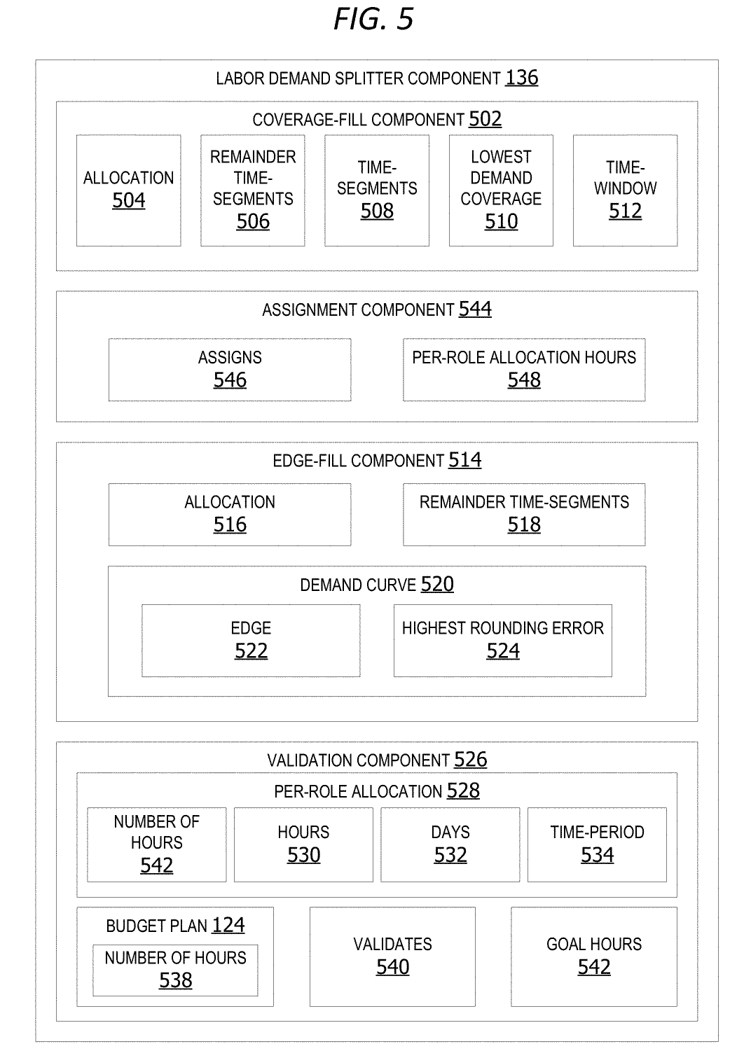

FIG. 5 is an exemplary block diagram illustrating a labor demand splitter component 136 performing coverage-fill and edge-fill. A coverage-fill component 502 performs an allocation 504 of remainder time-segments 506 to one or more time-segments 508 of the selected day having a lowest demand coverage 510 during a user-selected time window 512.

In some examples, the coverage-fill component 502 adds remainder time-segments 506 to the lowest demand level during the selected time window 512 beginning at a last edge for a selected day. The coverage-fill component adds a time segment to each edge based on a set of edges with a highest rounding error until there are no un-allocated remainder time-segments remaining to generate a set of per-role allocation hours for each day during the selected time-period.

An edge-fill component 514 performs an allocation 516 of remainder time-segments 518 on an edge 522 of a demand curve 520 having a highest rounding error 524 until all remainder time-segments 518 have been allocated.

A validation component 526 compares a generated per-role allocation 528 of hours 530 for each day 532 in a given time-period 534 with the budget plan 124 for the selected role during the given time-period. The validation component 526 validates 540 the generated per-role allocation of hours for the selected role if the number of hours 542 allocated to the selected role during the plurality of days in the given time-period is equal to the number of hours 538 budgeted for the selected role during the given time-period. The validation component 526 outputs the generated set of per-role allocation hours for the selected role on condition the set of per-role allocation hours are validated based on goal hours 542 of the budget plan 124.

An assignment component 544 assigns 546 the generated set of per-role allocation hours 548 to the selected role on condition the set of per-role allocation hours are validated based on the budget plan.

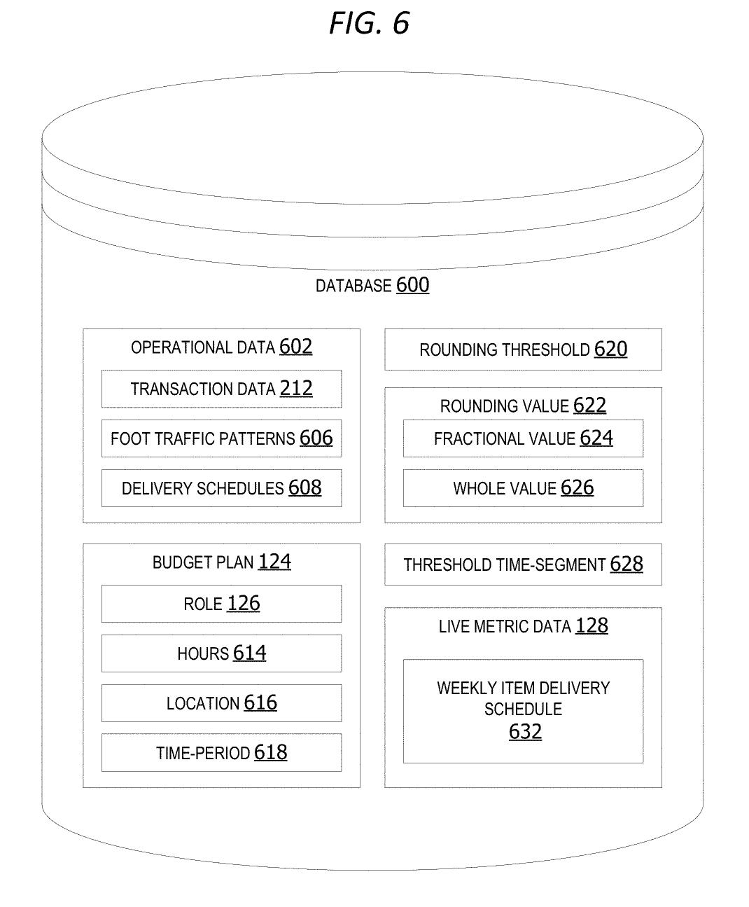

FIG. 6 is an exemplary block diagram illustrating a database 600. Operational data 602 associated with a selected location can include, without limitation, transaction data 212, foot traffic patterns 606, and/or truck delivery schedules 608.

The budget plan 124 includes a plurality of hours 614 allocated to a selected role 126 at a selected location 616 for a selected time-period 618. The database can also store a rounding threshold 620 and/or a rounding value 622. The rounding threshold 620 defines a threshold for rounding, indicating whether a value should be rounded up or rounded down. If the rounding value is zero, rounding is disabled for the specified role.

The rounding value 622 is utilized by the week splitter component and/or the intra-day splitter component to round a fractional value 624 to a whole value 626 based on the rounding value 622. The rounding value 622 defines an integer value for rounding a role's hours. A role can be rounded to the nearest 8 hours, the nearest 12 hours, the nearest 3 hours, etc. If the rounding value is zero, rounding is not performed for the given role.

A threshold time-segment 628 in some examples is a threshold segment of time. A threshold time-segment 628 can include, without limitation, a half-hour (thirty-minute) time-segment, a fifteen-minute time-segment, a ten-minute time-segment, a twenty-minute time-segment, a forty-five-minute time-segment, or any other time segment.

The live metric data 138 includes a weekly item delivery schedule 632 for the item selection area. The weekly item delivery schedule 632 includes the day and time of each delivery truck or pallet scheduled to be delivered to the item selection area within a week. However, the examples are not limited to a weekly item delivery schedule. The live metric data 138 can include operational metrics, such as truck delivery schedules, for a one-month time-period, a two-week time-period, a daily time-period, or any other time-period.

In other examples, the database 600 stores other data and/or configuration criteria utilized for labor demand allocations. For example, the database 600 can include like-store definitions for a selected store. The like-store definitions include an identification of stores which can be used to override stores' metrics with sister store metrics. The monthly and weekly splitters use this data for metric splits where operational data, seasonal data, or other historic data for the selected store is unavailable.

In other examples, a weekly budget round order defines the order in which hours are redistributed from one role to another. A remainder receivers designation defines one or more approved to receive weekly budget remainders generated during rounding on of allocations to a selected role.

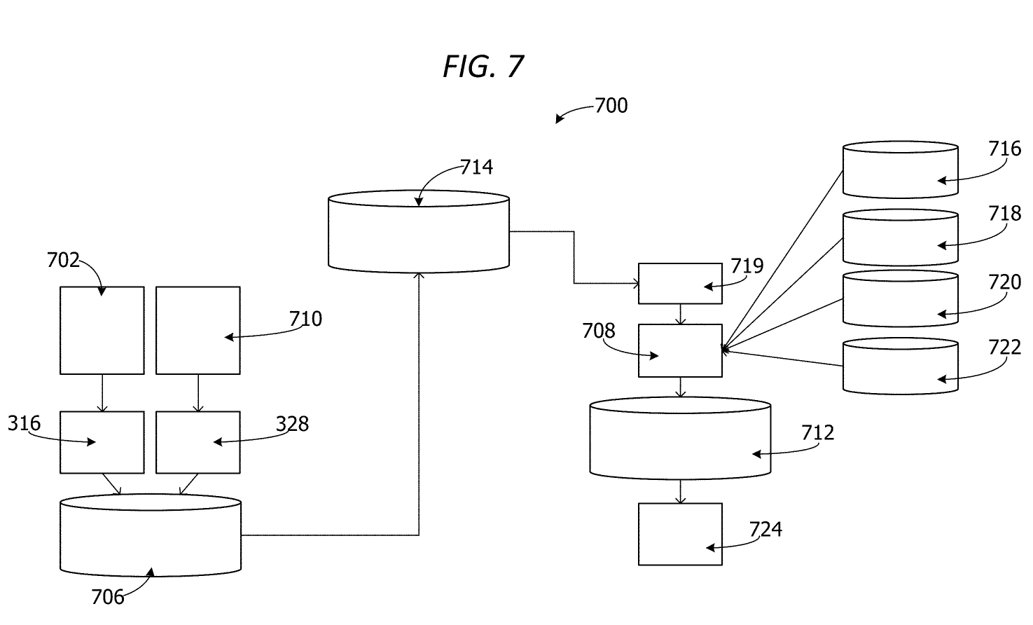

FIG. 7 is an exemplary block diagram illustrating a demand generation process 700. The labor demand splitter component begins by splitting a monthly budget 702 plan for a selected role into days. The budget 702 can be a month budget file, such as a text file. A month splitter component 316 utilizes a planning version of the role configuration file, including configuration settings specific for plan splitting. The labor demand splitter component specifies the planning table 706. In some examples, the planning table 706 is kept separate from the demand generation table 712 so the budget plans can be created without interfering with the weekly demand generation process.

A week splitter component 328 component splits a week budget 710 on select roles as needed if there is a desire to correctly re-split structure roles to correct the day of the week. At the end of the monthly planning, weekly goal hours by role are loaded onto a weekly goal by role table 714. In some examples, the week splitter component 328 looks at the number of hours split by the month splitter. The week splitter component 328 analyzes the number of hours split in monthly split process and determines how a week is defined for the location. For example, a week can be defined as Saturday through Friday. In another example, a week can be defined as Sunday through Friday. In still another example, the week can be defined as Monday through Friday.

In some examples, the labor demand splitter loads live metric data from one or more day live metric tables 716. The live metrics include data such as, truck schedules, store operating hours, and cashier curves that frequently change and are not available during plan splitting. The truck delivery schedules can be loaded from a user-specified group of text files. Daily data is calculated from intra-day split 724 data. Total format data is calculated for both daily live metric data and month split metrics 718.

In one example, roles associated with unloading trucks are allocated hours based on the truck delivery schedules. In another example, a cashier's role can be allocated hours based on transactions and foot traffic. The store's specific operating hours permit the system to configure a role to cutoff when the store is closed as defined by the store hours of operation.

In some examples, the labor demand splitter re-split weekly goal hours into days. The demand generation occurs weekly to ensure the latest live metrics are accounted for in the demand and that operational metrics are accommodated for the per-role/task splitter 719. The system can use month plan split metrics 718 for roles that do not require live metrics, such as, without limitation, maintenance personnel that perform the same tasks regardless of changing foot traffic, truck schedules, predicted sales, etc.

The labor demand splitter in other examples loads and configures special custom seasonal metrics 720 tied to a role for a specific event. A seasonal metric can include metrics associated with holidays, such as, but not limited to, Easter, Valentine's day, and/or Thanksgiving.

The labor demand splitter can also load fixed events 722 to for a selected role. A fixed event 722 is an event that happens only occasionally and receives a fixed number of hours for the task. For example, a book-keeping task can only be performed on the last day of each month and consume two-hours of time. Therefore, this is a fixed event 722 that is not allocated via the labor demand splitter as the time allocated to the fixed event does not vary based on live metrics nor does it occur on more than one day per month.

The labor demand splitter component applies daily rounding to specified roles and spreads daily values in the demand table to quarter-hour demand for specified roles in some non-limiting examples. The labor demand splitter spreads specified roles over quarter-hour metrics with spike and valley removal to match a daily budget. The system outputs per-role demand allocation data in an output file.

A validation component verifies that the generated per-role demand allocation is consistent with the per-role budget. The system validates that the generated demand for a selected role validates back to the weekly goal hours for that selected role. In one non-limiting example, the output per-role demand allocation is provided in an extensible markup language (XML) format. The system archives this XML file for later analysis.

The demand validation and reporting, in some examples, includes finding outliers for stores and/or roles that are changing value week-over-week, failing to match weekly adjusted budget and/or demand not tracking to original plan. The validation component can utilize trending of demand with a budget plan to ensure stores labor demand allocations match a predetermined budget every week.

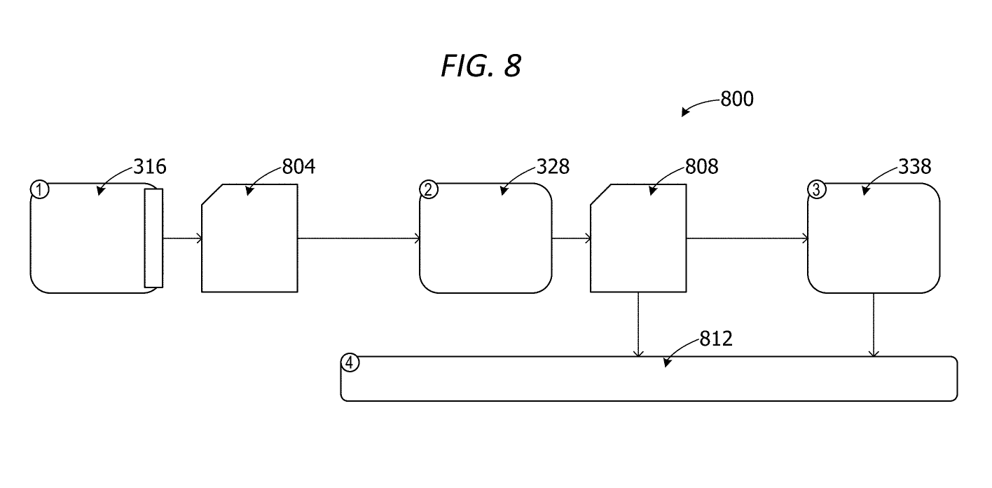

FIG. 8 is an exemplary block diagram illustrating a demand generation process 800 using live metric data. A month splitter component 316 splits a monthly budget plan for a given role into daily and weekly plan hours by role 804. A week splitter component 328 utilizes live metric data such as truck delivery schedules, to perform daily and weekly revised (re-split) hours by role 808 for roles which are dependent/influenced by variable operational metrics, such as, but not limited to, truck loading and un-loading roles. An intra-day splitter component 338 utilizes advanced spread to further split daily hours into intra-day time-segments. The advanced spread can include edge-filling, forecast routine spreading, coverage-filling, rounding, etc. The labor demand splitter outputs a validated per-role demand allocation 812 to at least one user. The user utilizes the validated per-role demand allocations to assign users to work time-slots for an upcoming week based on their roles/tasks for the upcoming week. For example, the validated per-role demand allocation for a cashier role is utilized to schedule/assign a cashier to days of the week and hours (times) of the day during which the cashier is assigned to be on duty (at work).

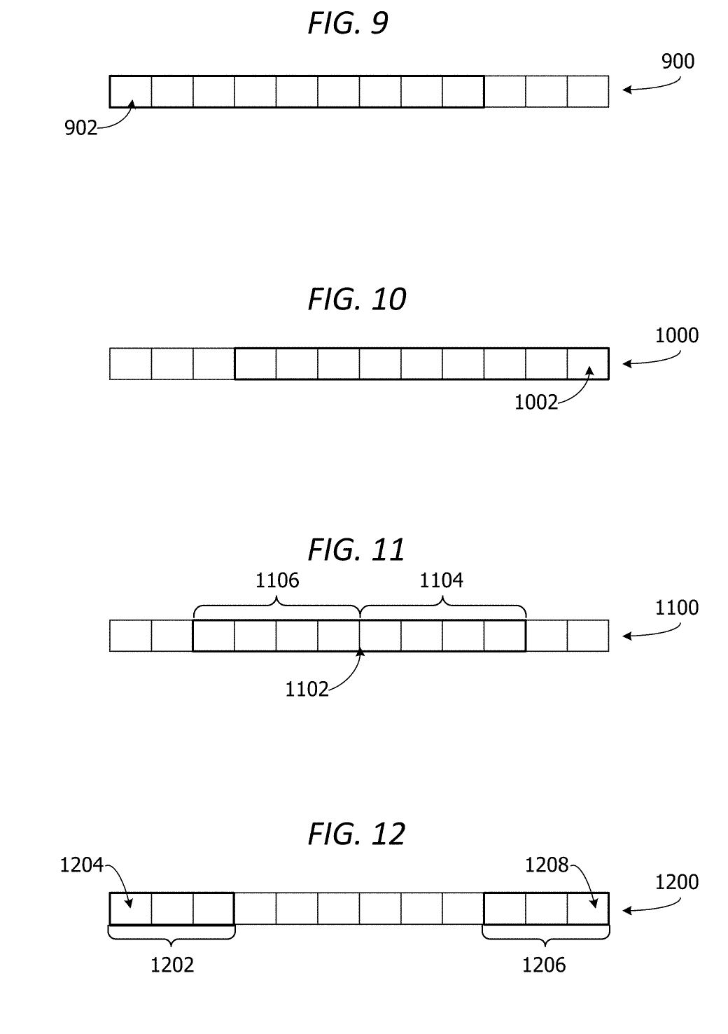

FIG. 9 is exemplary block diagram illustrating an intra-day forward spreading routine 900. The forward spreading routine 900 starts spreading hours or time-segments at a start time 902 and distributes remaining time-segments going forward until there are no remaining hours/time-segments to be allocated.

FIG. 10 is exemplary block diagram illustrating an intra-day reverse spreading routine 1000. The reverse spreading routine 1000 starts spreading hours or time-segments at an effective end time 1002 and distributes remaining time-segments going backwards (in reverse) until there are no remaining hours/time-segments to be allocated.

FIG. 11 is exemplary block diagram illustrating an intra-day midpoint spreading routine 1100. The midpoint spreading routine 1100 starts spreading hours or time-segments at a user-specified midpoint time 1102. A midpoint spreading routine can be used for a role where all tasks are routine (uninfluenced by variable factors). For example, a maintenance role tasked with cleaning shelves, sweeping floors, emptying trash cans, and so forth is all routine. The midpoint spreading routine begins at a midpoint and works backwards and forwards from the midpoint. If a role has nine hours to spread for a given day, the system begins at the midpoint and spreads outward on both sides. This can be used for routine work.

The routine 1100 in this example spreads remaining time going forward and backwards from the midpoint until there are no remaining hours/time-segments to be allocated. In this example, the hours are spread going forward at 1104 and going in reverse at 1106.

FIG. 12 is exemplary block diagram illustrating an intra-day endpoint spreading routine 1200. The endpoint spreading routine 1200 starts spreading hours or time-segments from a first end time 1204 spreading forward at 1202 and from a second end time 1208 spreading backwards at 1206. The time-segments are spread equally between the two endpoints until there are no remaining hours/time-segments to be allocated.

FIG. 13 is an exemplary flow chart illustrating operation of the computing device to generate a validated per-role demand allocation. The process shown in FIG. 13 can be performed by a labor demand splitter component, executing on a computing device, such as the computing device 102, the user device 116 and/or the computing device 118 in FIG. 1.

The process begins by obtaining inputs at 1302. The inputs can include operational data and/or live metric data associated with a selected role. The inputs can also include raw demand and/or lists of individual tasks with demand effective times. The labor demand splitter splits the budget into days at 1304. The budget can be split/allocated to individual days by a month splitter component and/or a week splitter component. The labor demand splitter is a component, such as, but not limited to, the labor demand splitter component 136 in FIG. 1, FIG. 3, FIG. 4 and/or FIG. 5.

The labor demand splitter spreads the daily values to intra-day values at 1306. The labor demand splitter performs demand validation and reporting at 1308. The process terminates thereafter.

While the operations illustrated in FIG. 13 are performed by a computing device, aspects of the disclosure contemplate performance of the operations by other entities. For example, a cloud service can perform one or more of the operations.

FIG. 14 is an exemplary flow chart illustrating operation of the computing device to generate a per-role demand allocation using an intra-day forecast spreading routine. The process shown in FIG. 14 can be performed by a labor demand splitter component, executing on a computing device, such as the computing device 102, the user device 116 and/or the computing device 118 in FIG. 1.

The process retrieves a budget plan for a role at 1402. The budget plan is a pre-generated budget for a role, such as the budget plan 124 in FIG. 1. The budget plan is obtained by a data loader, such as the data loader component 302 in FIG. 3. The budget plan can be loaded as a file in some examples.

The labor demand splitter analyzes the budget plan and operational data using per-role configuration criteria and per-role metric weights at 1404. The per-role metric weights include weights, such as, but not limited to, the set of per-role metric weights 134 in FIG. 1 and/or the per-role metric weights 322 in FIG. 3 and/or FIG. 4. The labor demand splitter allocates a set of hours to each day based on the analysis results and live metric data at 1406. The per-day allocation can be performed by the month splitter component and/or by the week splitter component.

An intra-day splitter spreads the hours across time-segments for a selected day based on a selected forecast spreading routine at 1408. The forecast spreading routine can include, without limitation, a mid-point spreading routine, an end-point spreading routine, and/or a metric spreading routine. The forecast spreading routine is a routine such as, but not limited to, the forecast spreading routine 344 in FIG. 3.

The labor demand splitter performs edge-fill and/or smoothing at 1410. The labor demand splitter validates the allocated hours against the budget at 1412. The labor demand splitter determines if the allocation is valid at 1414. If no, the process terminates thereafter.

If the allocation of hours to the selected role is valid, the labor demand splitter outputs the allocation to the selected role at 1338. The process terminates thereafter. The selected role is a role, such as, but not limited to, the selected role 126 in FIG. 1, FIG. 2, FIG. 4 and/or FIG. 6.

While the operations illustrated in FIG. 14 are performed by a computing device, aspects of the disclosure contemplate performance of the operations by other entities. For example, a cloud service can perform one or more of the operations.

FIG. 15 is an exemplary flow chart illustrating operation of the computing device to generate a validated per-role demand allocation using a midpoint spreading routine. The process shown in FIG. 15 can be performed by a labor demand splitter component, executing on a computing device, such as the computing device 102, the user device 116 and/or the computing device 118 in FIG. 1.

The process begins by determining whether a midpoint spreading routine is selected at 1502. If yes, the labor demand splitter spreads hours for a role equally on both sides of a midpoint time segment toward end-points at 1504. The labor demand splitter determines if all hours are allocated at 1506. If no, the process returns to 1502 and iteratively executes operations 1502 through 1506 until all hours are allocated. The process terminates thereafter.

FIG. 16 is an exemplary flow chart illustrating operation of the computing device to generate a validated per-role demand allocation using an endpoint spreading routine. The process shown in FIG. 16 can be performed by a labor demand splitter component, executing on a computing device, such as the computing device 102, the user device 116 and/or the computing device 118 in FIG. 1.

The process begins by determining whether an endpoint spreading routine is selected at 1602. If yes, the labor demand splitter spreads hours from a first endpoint and a second endpoint to a midpoint at 1604. The labor demand splitter determines if all hours are allocated at 1606. If no, the process returns to 1602 and iteratively executes operations 1602 through 1606 until all hours are allocated. The process terminates thereafter.

While the operations illustrated in FIG. 16 are performed by a computing device, aspects of the disclosure contemplate performance of the operations by other entities. For example, a cloud service can perform one or more of the operations.

FIG. 17 is an exemplary graph 1700 illustrating intra-day metric spread of labor over a plurality of time-segments. Per-role configuration criteria specify a combination of metrics used to perform intra-day spread of labor for a selected role. The per-role configuration criteria include configuration criteria, such as, but not limited to, the set of per-role configuration criteria 132 in FIG. 1 and/or FIG. 3.

The system spreads a role over one or more intra-day metrics (ex: cashier) and ensures the spread of intra-day demand matches daily budget. The system uses live metrics to source the intra-day metrics in the data loader. The system rounds the labor demand to FTEs. The system smooths the labor demand to reduce spikes and gaps in demand to be more acceptable to the store/business.

In one non-limiting example, the per-role configuration criteria can include a ten-percent fixed, forty-percent belted items and fifty-percent belted customers. In other words, ten-percent of hours are fixed, forty-percent of the hours are allocated in accordance with transactions (items), and fifty-percent based on foot traffic (customers). The labor demand splitter calculates the percentage of the day for each time-segment based on the metric configuration. In this example, the percentage of the day is calculated for each fifteen-minute time-segment based on the metric. The configured effective time is honored when calculating the percentages, so the total day percentages add up to one-hundred percent.

The line 1702 in the graph 1700 shows the labor spread over that percentage shape dictated by the per-role configuration criteria and the live metric.

FIG. 18 is an exemplary graph 1800 illustrating intra-day metric spread rounding. The per-role configuration criteria include intra-day rounding options, such as a rounding interval and/or a rounding value. In this example, the labor demand splitter rounds each fifteen-minute interval at a round threshold of 0.5. At less than half (0.49), the system rounds the time down to zero. At half (0.50) or more, the system rounds the time up to one (1.0). For example, if the budget allows for 2.3 persons, it rounds down to 2.0 persons because three-tenths of a person cannot be scheduled for a given time-segment.

In this graph 1800, the line 1802 is the sum of initial intra-day spreading. The line 1704 represents the sum of rounded intra-day spreading values.

FIG. 19 is an exemplary graph 1900 illustrating intra-day metric spread smoothing. The per-role configuration criteria include a user-selected smoothing time window. In one non-limiting example, the smoothing time window is a seventy-five minute (or five segments). The intra-day splitter iterates over the data detecting peaks and valleys within the time window. The intra-day splitter fills in valleys and rounds down peaks.

In the graph 1900, the line 1902 is the sum of initial intra-day spreading. The line 1904 represents the sum of rounded intra-day spreading values after filling in valleys and smoothing down peaks. For example, where the peak 1906 exceeds three persons, the valley in line 1902 is smoothed down to 3.0 at 1908. Likewise, where the valley 1910 is slightly below three, the line 1902 is filled up to three (3.0) at 1912.

Thus, in an initial rounding pass, less than half FTE (0.5) is rounded up. During a second rounding pass, peaks and valleys are cleaned up. During the last phase, the system makes adds and subtracts remainders to make the budget match.

FIG. 20 is an exemplary graph 2000 illustrating intra-day metric spread budget match. The labor demand splitter calculates a sum of demand versus daily budget. If the demand is over the budget, the intra-day splitter removes time from the top edges based on priority. In some examples, the intra-day splitter calculates the difference between final demand and initial demand where the final demand minus the initial demand equals the priority (final-initial=priority). The intra-day splitter sorts the top edges to remove time-segments from the largest gap first. In this manner, the intra-day splitter sorts priority from largest to smallest. The intra-day splitter recalculates new edges and priority after each pass to ensure the new edges are prioritized appropriately.

The graph 2000 illustrates an initial intra-day spreading at line 2002. The top edges 2004, 2006, 2008, 2010, 2012 and 2014 represent the higher time slot of an edge.

The corners are ranked in this example. The first corner 2004 has the biggest gap between raw demand and the rounded demand. The system shaves 2004 first. The second corner 2006 is shaved next. The shortest ones are shaved/adjusted by adding or removing time-segments until the allocated demand matches the budget via edge-fill and coverage-fill.

FIG. 21 is an exemplary graph 2100 illustrating edge-fill and coverage fill. The intra-day splitter calculates the sum of demand versus a daily budget. If demand is under budget, the intra-day splitter adds hours to the bottom edges based on the configuration.

The graph 2102 illustrates edge fill remainders. The intra-day splitter starts from a last edge of the day and adds a time-segment to each edge until no remainders are left. The intra-day splitter starts over the end of the day if needed.

The graph 2104 illustrates coverage fill remainders. The intra-day splitter determines the lowest demand level and only adds to that level. The intra-day splitter starts from the last edge of the day. The intra-day splitter adds a time-segment to the edges until no remainders are left. The intra-day splitter moves to the next level up, if the lowest level fills up completely.

In this manner, the labor demand splitter component matches the budget plan for each role directly while performing edge-filling, smoothing, and forecast spreading rather than simply rounding to a pre-configured threshold as in previous solutions.

FIG. 22 is an exemplary table 2200 illustrating rounding values and rounding threshold. Each role 2202 in this example is assigned a rounding value 2204. The remainder threshold 2206 is the threshold remainder value after applying the rounding value 2204.

For example, if the rounding value for a store-role is four hours (4.0 hrs.), the daily budgeted hours are rounded down by the rounding value. In one example, the daily budget is divided by the rounding value to obtain a quotient. The quotient is multiplied by the rounding value to obtain the rounded number of hours allocated to that role for that day. The first operand is rounded down to an integer prior to multiplying it back to rounding value. The rounded number of hours are subtracted from the original daily budgeted hours. The equations are as follows:

$$option 1 \text{:} int ( \frac{Budget Hrs}{Rounding Value} ) * Rounding Value = Daily Allocation Value$$

$$O ption 2 \text{:} Budget Hrs - ( Budget Hrs mod Rounding Value ) = Daily Allocation Value$$

$$Budget Hrs - Daily Allocation Value = Remainder$$

In one example, if the budgeted hours are 13.5 hours and the rounding value is four (4.0), the daily allocation value is twelve and the remainder is 1.5. The rounding value is applied to each day. In this example, the rounding value is zero for role 1. The rounding value of zero indicates no rounding is performed.

The daily budget is the daily value retrieved from the budget split table, populated by the month and week splitters. The round value is the value set for each role by one or more users. It allows a user to force the daily budget to round up or down to the nearest round value. For example, a round value of four means that a daily budget of fourteen becomes twelve or sixteen (multiples of four).

The round threshold is a value set for each rounded role by users. The round threshold allows a user to specify a threshold at which a daily value is rounded up or down. For example, if a threshold is four and the remainder is 4.1, the system rounds up. But if the remainder is 3.9, the system rounds down. This determines the total weekly error that is possible when rounding daily values. Higher values lean towards being under budget, while lower values lean on the side of being slightly over budget. A threshold of half (½) of the found value can cause an even split of over and under.

The remainder is the amount of time left over after rounding down a day. For example, a round value of four applied to a daily budget of fourteen yields a remainder of two, because the daily budget is rounded down to the nearest multiple, which is twelve in this example.

The remainder bucket is a weekly total of remainders. The weekly error is the error between budget and demand at the total week after round threshold is applied to each day. This is an outcome that depends on the original weekly budget value, the round value and round threshold. The labor demand splitter allocates remainders for the week one day at a time until it runs out of remainders, the weekly error is only as large as a single day's possible error. The weekly error can range between the round value and the difference of the round threshold minus the round value.

For example, if the round value is eight and the round threshold is five, the weekly error range is between the difference of five minus eight (5−8) and the round threshold of five, (or between −3 and 5)]. In one example, the daily budget for each day within a week for a store or role is run through a modulus operation to get the remainder of the daily budget after the round value is applied. For example, twenty mod six equals two (20 mod 6=2), because twenty is evenly divisible by six (three times) but leaves a remainder of two. The remainder is added to the remainder bucket for the week. Essentially, the system initially rounds down every day of the week to the nearest multiple of the round value.

The days of the week are re-ordered, first in order of daily remainder from greatest to least, then in order of day of week. If Monday and Thursday have the same remainder, Monday is processed before Thursday. Otherwise, if Thursday has a greater remainder than Monday, Thursday is processed before Monday. For each day of the re-ordered week, if our remainder bucket is greater than or equal to the round threshold, round value is added back to that day of the week. This is done one day at a time until the remainder bucket is zero, or the remainder bucket is less than round threshold.

In a non-limiting example, if the round value is eight and the round threshold is four, the daily budget for the days of the week (Saturday-Friday) is as follows:

Saturday—10 hours;

Sunday—12 hours;

Monday—7.5 hours;

Tuesday—8 hours;

Wednesday—9 hours;

Thursday—8 hours; and

Friday—14 hours.

The days of week with remainders for each week after the initial round down is as follows:

Saturday—8 hours with remainder of 2.0;

Sunday—8 hours with remainder of 4.0;

Monday—0 hours with remainder of 7.5;

Tuesday—8 hours with no remainder;

Wednesday—8 hours with remainder of 1.0;

Thursday—8 hours with no remainder; and

Friday—8 hours with remainder of 6.0.

After reordering, the days of week with remainders are as follows:

Monday—0 hours with remainder of 7.5;

Friday—8 hours with remainder of 6.0;

Sunday—8 hours with remainder of 4.0;

Saturday—8 hours with remainder of 2.0;

Wednesday—8 hours with remainder of 1.0;

Tuesday—8 hours with no remainder; and

Thursday—8 hours with no remainder.

The remainder bucket has a total of 20.5 hours. The labor demand splitter adds the round value a day at a time to the reordered week if our remainder bucket is greater than or equal to round threshold. The days of the week with hours and remainder bucket values are as follows:

Monday—8 hours with remainder bucket of 12.5;

Thursday—16 hours with remainder bucket of 4.5; and

Sunday—16 hours with remainder bucket of zero.

In this example, eight hours are added to Monday to provide 12.5 hours to spread. The labor demand splitter adds eight hours to Thursday, which provides 4.5 hours to spread. The round threshold was four, so the labor demand splitter adds eight hours to Sunday as well. Because the labor demand splitter rounded up, it is over-budget this week. The maximum amount a store/role/week can be over/under budget is the difference between the round value and the round threshold. The higher the round threshold, the more likely the allocation can be under budget. The lower the round threshold, the more likely the allocation can be over budget.

Weekly budget rounding and redistribution includes a weekly budget round order which specifies the order in which the system reallocates hours from role to role, such as, but not limited to, smallest to largest. The remainders receivers (designated remainder receivers) is a list of budget role names approved to receive the rounding errors from the rounded roles. The weekly budget rounds the budget down to the next multiple of the round value and redistributes it to the designated receiving roles.

In some examples, when weekly budgets are loaded for all roles for a store, the roles are sorted according to the weekly budget round order, from first to last. The first role's budget is compared to the round value. For example, if the round value is eight and the weekly budget for that store and/or role is forty-two. The extra two hours' do not align evenly to eight-hour shifts, so the remainder of two is removed from the budget for that store/role. The first role found in the designated receiving roles list that has a budget receives the remainder. If the system is rounding role “X”, which has a budget of forty-two and a round value of eight, the remainder of two is removed from the role “X”, leaving the role “X” with forty hours. The first designated role to receive the remainder, role “A” having a budget of thirty-six receives the remainder of two hours. The remainder of two from the role “X” is added to the role “A”, so the budget for “A” is increased to thirty-eight hours. If an approved receiving role is not found, the system outputs an error.

Rounding values can define how the labor demand splitter handle hours for days that don't cleanly align to a specific number of hours. For example, if overnight shifts should always be eight (8.0) hours, but the budgeted hours don't always align exactly to eight-hour shifts. Rounding solves this problem. The rounding feature limits the error in the total week round down each day and then adds back remainders, preventing each day's rounding error to add up to significant values.

In some examples, daily rounding applies to an XML generator. In these examples, neither the month or week splitter applies daily rounding logic, therefore they do not store rounded data.

FIG. 23 is an exemplary table 2300 illustrating budget-driven labor demand allocation. In some examples, metric splits permit the labor demand splitter to split hours allocated for a day among quarter-hour time segments much like we split monthly and weekly budgets by metrics. Metric splits can apply to month, week, and intra-day splits. A budget can be split based on the forecast workload of every day of a month, every day of a week, or every time segment of a day. The labor demand splitter utilizes daily workload percentages for multiple different metrics applied to a single role to split the budget for that role across a month, across a week, across a day, or within a day (intra-day).

In this non-limiting example, the daily workload percentages for the group of metrics includes items 2302 at 70%, cases 2304 at 10%, fixed demand 2306 at 20%, and customer counts (foot traffic) at zero. The metrics marked as 0% are skipped. If a percentage is specified for a metric that is not included in the metric group, such as a metric the metric group does not pull, the system outputs an error. In this non-limiting example, the daily workload percentages for items 2302 include the following values: 0.209923664, 0.183206107, 0.076335878, 0.114503817, 0.106870229, 0.133587786, 0.175572519. The daily workload percentages for cases 2304 include the values: 0.161290323, 0.241935484, 0, 0, 0.129032258, 0.274193548, 0.193548387, and so forth. The daily metric for fixed is calculated by dividing one by seven (7 days in a week), which yields a value of 0.142857 per day. The table 2300 illustrates the results if the one-hundred and twenty (120) budgeted hours are split according to these metrics.

For Items 2302, the labor demand splitter takes 70% of the one-hundred and twenty, which is eighty-four, and multiplies it by the daily percentages for the items 2302 to yield the daily hours. For cases 2304, the labor demand splitter takes 10% of the one-hundred and twenty, which is twelve, and multiplies it by the daily percentages for the cases (shown in row 8) to yield the daily hours for the cases shown in row 9. For the fixed demand 2306, the labor demand splitter takes 20% of the one-hundred and twenty, which is twenty-four, and multiplies it by the daily fixed percentage (shown in row 12) to yield the daily hours for the fixed demand. The labor demand splitter adds the daily hours for each metric together to yield the daily total budgeted hours. When the total daily hours are summed up, it equals the one-hundred and twenty, which matches the budget total. These daily demand values get stored in the database.

### ADDITIONAL EXAMPLES

In some examples, the system matches labor demand allocation to a budget based on live metrics, seasonal demand, event-driven metrics, edge-filling allocated time segments, coverage fill, offsetting, and user-defined forecast spreading routines for intra-day splitting of demand hours during a given month. A verification component ensures the allocated hours for the month match the monthly budget.

The system in other examples generates workload demands for scheduling by receiving input of workload and budget while ensuring direct match of the workload, budget, and demand in a three-way match. Further, the system enables scheduling demand in a different shape than a forecast workload to meet scheduling needs via offsetting. The system enables contiguous demand scheduling prioritized to middle or endpoints of a day (midpoint/endpoint demand spread methods). A demand metric spreader smooths out peaks and valleys to further improve accuracy and suitability of the per-role allocation of hours and ensures a direct match to daily budget.

The labor demand splitter in some examples employs daily rounding to ensure partial shift demand is not allocated to a role. The labor demand splitter ensures truck schedule accountability, permits role redistribution. In one example, the system rounds roles to eight-hour shifts and redistributes remainder time-segments to another role to ensure feasible eight-hour shifts on some selected roles.

In other examples, endpoint spreading is utilized to cover endpoints of the day before the middle of the day. Intra-day demand curve spreading can be utilized with rounding and smoothing (solving for the cashier curve), live metrics, seasonal/holiday demand override functionality (holiday management), data validation, accuracy tools and dashboard (process monitoring). In one example, a fifteen-minute intra-day demand metric spreader smooths out peaks and valleys and ensures a direct match to daily budget and constrains the spread of hours based on a stores hours/day of operation (open hours).

In an example scenario, the system splits a monthly budget plan into days on a quarterly basis. The system splits the monthly budget into weeks and then splits the weekly budget into days/tasks using forecast metric spreading. The system can utilize offsetting of original labor demand to a live metric, configuration-defined shape spreading (tiers approach), configuration-defined daily minimums, daily rounding/reallocation to ensure exact budget match, role rounding/reallocation to ensure exact budget match, task-group splitting, and/or customized daily spread methodology or metrics for specified weeks/dates to generate a per-role demand allocation.

The system in other examples loads live metrics and re-splits the weekly goal hours into days on a weekly basis. Weekly goal hours can be re-split due to changing live metrics, changing operational metrics due to seasonality/events, changing weekly budget, etc. The system accommodates “live metrics” and changing configuration needs, including holidays and other events.

In one example, the system proportionally aligns a monthly budget for a day stock and overnight stock roles to the workload related to truck delivery days at the store within the labor demand splitter application. The labor demand splitter allocates weekly hours by role to truck delivery days. The input in these examples can include truck delivery data.

A budget, in some examples, is created to align to a fixed role and the fixed role is split to align to the budget. The splitter is intended to split multiple months in one run. Therefore, a number is not entered in the fixed role configuration that absolutely aligns with the budget. If we have a split role with a configuration that specifies the role receives eight hours per day on Sunday through Thursday and the role receives sixteen hours on Friday and Saturday, a month which has five Fridays and five Saturdays receives three-hundred and twenty-eight hours. Another month having only If four Fridays and four Saturdays receives two-hundred and ninety-six hours. This is almost a difference of an FTE. The system can use the maximum type monthly budget that is less than or equal to the role budget. Using this approach, it's possible to select one of three types of spreads. The three spread types include fixed spread, fixed-shape and variable. The spread type applies to the entire role; the spread type does not change based on how many hours are budged for that role (i.e., the threshold).

For a fixed spread type, the daily hours are applied to each day of the week. No extra adjustments, formulas, etc. are applied. In fixed-shape spread type, the daily hours are assigned to every day throughout the month or week (depending whether we're running the month or week splitter, respectively), and summed into one number—a fixed total. The monthly budget is divided by the fixed total to yield the percentage difference between the two. The daily budget numbers that were assigned are then adjusted by this percentage difference.

For example, let's say this is our hours distribution for a week: 8, 8, 4, 4, 4, 8, 8. The sum of these hours is forty-four. The labor demand splitter divides each day's hours by the sum of hours (x/44) to yield daily percentages: 0.182, 0.182, 0.091, 0.091, 0.091, 0.182, and 0.182. If the actual budged hours are forty-eight, the labor demand splitter multiplies forty-eight by each daily value (x*48): 8.74, 8.74, 4.37, 4.37, 4.37, 8.74, 8.74. This ensures the split meets the actual budget, rather than potentially going over or under, as could happen with the ‘Fixed’ spread type. The variable spread type splits the budget based on a metric.

In cases where the split result doesn't match the budget, the system adjusts the fixed roles on the fly to match budget. This ensures the allocated hours align to a budget without going over-budget or under-demand. This avoids remainder time leftover. The labor demand splitter adjusts the fixed role demand to match the budget also gives the user an opportunity to adjust the budget or role configuration as necessary and re-split at the weekly level. This also prepares us to handle minimums and fixed events.

The system generates a budget-driven workload customized based on each store, role and predicted demand. The system does not calculate or create the workload demand allocation at the fifteen-minute level, which frequently results in bandwidth issues due to the resource intensity of such calculations.

The system in some examples generates an extensible XML including the generated per-role demand allocation on a weekly basis. The system performs a weekly demand validation and sing-off. The system can optionally re-load demand as needed. The per-role allocation hours are delivered to an operational team that turns the budget (allocated hours) into a schedule. The operations team creates a schedule for the per-role allocation hours that is a match for the budget plan and accurate to the workload shape and demand.

The budget is a workload driven budget for wages. It is a budget for labor (salaries) for a month (monthly budget) or a week (weekly budget). The budget is provided to the system for allocation on a daily (intra-day) level for each role. The budget is spread and divided among all the different shifts throughout the day. A spreading methodology is selected by the system based on per-role configuration settings, live metric data, an amount of fixed work, etc. The level of configuration put on each role and the store specific nature of the spreading methodologies permits the system to allocate workload at right time of day and right day of week based on store needs and budget constraints.

In one non-limiting example, if the labor budget for a cashier roll is one-hundred hours for a week, the system spreads that one-hundred hours weekly budget over the operational days of the week. The operational days of the week can be seven days or less than seven days if the store is closed one or more days a week. In this example, the system allocates twenty hours to Saturday, fifteen hours to Sunday, fourteen hours to Monday, etc. Friday receives the highest daily allocation of twenty hours due to higher traffic and greater number of transactions predicted for Friday at this location.

In another example, an overnight stocker role is not dependent upon traffic or transactions at the store. Instead, the demand for overnight stockers are influenced by truck delivery schedules. When a truck arrives with items, the stocker is needed. The labor budget for the overnight stocker can be dependent upon the throughput of cases/pallets going to store. The hours for the stocker role are allocated based on expected truck deliveries.

A month splitter splits monthly budgets by store/role into daily values and stores them in a database table. A week splitter splits weekly budgets by store/role into daily values. The week splitter stores the daily values it generates into a database table. The intra-day splitter reads the table populated by the month/week splitters and dumps daily and intra-day XML files. A weekly live metric data loader loads truck schedule and cashier/transactions live metric data.

In some examples, edge-filling and smoothing is utilized to add hours or reduce hours in the intra-day allocation to ensure the aggregate shape and allocated hours equal the original budgeted plan. The system analyzes each fifteen-minute time-segment and looks at remaining hours after rounding is applied. The system determines if there are sufficient hours remaining to round up or add additional time-segments until the per-role allocated hours total matches the budget.

In this manner, a computing device executing the labor demand splitter component is used in an unconventional way and allows allocation of budgeted hours to a role with increased speed and reduced error without human intervention. The system outputs allocated hours to a user that conforms to a budget to improve user interaction performance assigning human personnel to a weekly work schedule conforming to both the budget and the per-role labor allocation, thereby improving the functioning of the underlying computing device.

The system generates predicted demand for products in a single store or multiple stores via role-level demand generation and/or task-level demand generation. The task-level generation includes a spreading algorithm that allows demand to generate at task-level by role with task effective times. This allows the spreading algorithm to generate demand at task-level, resulting in unique demand shapes for the role. And appropriately rounding the demand at role-level while maintaining accuracy (i.e. eliminating rounding error).

In some examples, the intra-day splitter applies an even-spreading method to accurately smooth hours across tasks at an aggregate level. In other examples, multiple smoothing algorithms are applied during allocation of hours across tasks during a given time-period at a given store (per-store level and per-task level).

Alternatively, or in addition to the other examples described herein, examples include any combination of the following:
a fixed demand metric associated with the selected role, wherein a month splitter component and/or a week splitter component allocates the set of hours to a selected day within the plurality of days based on a fixed demand task associated with the selected day;
a rounding threshold, wherein the week splitter component allocates the set of hours to each day in the plurality of days based on the rounding value and the rounding threshold, wherein the rounding threshold rounds labor demand during a week-to-day allocation in accordance with a predetermined threshold time segment;
a configuration option, wherein the week splitter component re-allocates all remaining hours from rounding to the selected role on another day in a week associated with the selected day or to a second selected role in the plurality of roles;
a rounding value, wherein the week splitter component rounds a fractional value to a whole value based on the rounding value;
an offsetting component, implemented on the at least one processor, calculating per-day demand based on a first set of metrics during a first portion of a per-day demand calculation and a second set of metrics during a second portion of a per-day demand calculation;
a week splitter component, implemented on the at least one processor, re-splitting a set of weekly goals for the selected role into the set of hours for each day in the plurality of days based on the live metric data and a set of event-driven metrics, the set of event-driven metrics comprising metrics associated with variable demand during holidays and local events associated with the item selection area;
a coverage-fill component, implemented on the at least one processor, allocates remainders to time-segments of the selected day having a lowest demand coverage;
the edge-fill component, implemented on the at least one processor, allocates remainder time-segments on an edge of a demand curve having a highest rounding error until all remainder time-segments have been allocated;
a validation component, implemented on the at least one processor, comparing a generated per-role allocation of hours for each day in a given time-period with the budget plan for the selected role during the given time-period;
wherein the validation component validates the generated per-role allocation of hours for the selected role if the number of hours allocated to the selected role during the plurality of days in the given time-period is equal to the number of hours budgeted for the selected role during the given time-period;
wherein the selected forecast spreading routing comprises a midpoint spreading routine;
spreading hours in a first set of hours beginning at a user-configurable mid-point time segment allocating hours equally on both sides of the user-configurable mid-point time segment, wherein the hours are spread away from the mid-point time segment toward a first end-point and a second end-point until all hours in the first set of hours are allocated;
wherein the selected forecast spreading routing comprises an end-points spreading routine;
spreading hours in a first set of hours from a user-configurable first end-point and a user-configurable second end-point equally toward a mid-point until all hours in the first set of hours are allocated;
adding, by a coverage-fill component, remainder time-segments to a lowest demand level during the selected time window beginning at a last edge for a selected day;
wherein the coverage-fill component adds a time segment to each edge based on a set of edges with a highest rounding error until there are no un-allocated remainder time-segments remaining;
calculating, by an offsetting component, a per-day demand associated with the selected role and the item selection area based on a first set of metrics during a first portion of a per-day demand calculation and a second set of metrics during a second portion of a per-day demand calculation;
assigning, by a fixed demand component, a subset of hours from the plurality of hours available in the budget plan to a selected day within the plurality of days based on a fixed demand task associated with the selected day;
a smoothing component, implemented on the at least one processor, that performs edge-filling and smoothing across a user-selected time window to reduce spikes and gaps in the set of hours spread across the user-selected time window to generate a set of per-role allocation hours for each day during the selected time-period;
the intra-day splitter component performing task-based allocations (per-task allocation) of hours across one or more tasks associated with a selected time-period and/or role using a set of one or more smoothing algorithms;
intra-day splitter component consolidates multiple tasks with multiple spreading algorithms;
providing rounding and smoothing algorithms that conforms to the original demand hours and the intended shape (do not gain or lose hours);
a coverage-fill component, implemented on the at least one processor, add remainder time-segments to a lowest demand level during the selected time window beginning at a last edge for a selected day;
wherein the coverage-fill component adds a time segment to each edge until there are no un-allocated remainder time-segments remaining to generate a set of per-role allocation hours for each day during the selected time-period;
the intra-day splitter, implemented on the at least one processor, spreads hours in a first set of hours beginning at a first end-point toward a mid-point until all hours in the first set of hours are allocated and spreads a second set of hours from a second end-point toward the midpoint until all hours in the second set of hours are allocated to a time-segment;
the intra-day splitter, implemented on the at least one processor, spreads hours in a first set of hours beginning at a mid-point toward a first end-point until all hours in the first set of hours are allocated and spreads a second set of hours from the mid-point toward a second end-point until all hours in the second set of hours are allocated to a time-segment.

At least a portion of the functionality of the various elements in FIG. 1, FIG. 2, FIG. 3, FIG. 4, FIG. 5, FIG. 6, FIG. 7, FIG. 8, FIG. 9, FIG. 10, FIG. 11 and FIG. 12, can be performed by other elements in FIG. 1, FIG. 2, FIG. 3, FIG. 4, FIG. 5, FIG. 6, FIG. 7, FIG. 8, FIG. 9, FIG. 10, FIG. 11 and FIG. 12, or an entity (e.g., processor 106, web service, server, application program, computing device, etc.) not shown in FIG. 1, FIG. 2, FIG. 3, FIG. 4, FIG. 5, FIG. 6, FIG. 7, FIG. 8, FIG. 9, FIG. 10, FIG. 11 and FIG. 12.

In some examples, the operations illustrated in FIG. 13, FIG. 14. FIG. 15 and FIG. 16 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for per-role demand allocation based on a pre-determined budget and predicted demand. For example, the elements illustrated in FIG. 1, FIG. 2, FIG. 3, FIG. 4, FIG. 5, FIG. 6, FIG. 7, FIG. 8, FIG. 9, FIG. 10, FIG. 11 and FIG. 12, such as when encoded to perform the operations illustrated in FIG. 13, FIG. 14, FIG. 15 and FIG. 16, constitute exemplary means for retrieving a budget plan associated with a selected role in the plurality of roles from a budget generator and live metric data associated with an item selection area via a network; constitute exemplary means for analyzing the budget plan using a set of per-role configuration criteria, historic operational data associated with the selected role, forecast metrics and/or a set of per-role metric weights; constitute exemplary means for allocating a set of hours from the plurality of hours to each week and/or each day in the plurality of days based on a result of the analysis and, live metric data associated with scheduled operations at the item selection area; constitute exemplary means for spreading the set of hours across a set of predetermined time-segments for the selected day based on a selected forecast spreading routine; constitute exemplary means for edge-filling and smoothing across a user-selected time window to reduce spikes and gaps in the set of hours spread across the user-selected time window to generate a set of per-role allocation hours for each day during the selected time-period; constitute exemplary means for validating the generated set of per-role allocation hours conforms with the budget plan during the given time-period; and constitute exemplary means for outputting, by an assignment component, the generated set of per-role allocation hours to the selected role on condition the set of per-role allocation hours are validated based on the budget plan.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it is apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for per-role customized labor demand allocation, the system comprising:
a memory;
at least one processor communicatively coupled to the memory;
a data storage device, communicatively coupled to the at least one processor, storing a budget plan associated with a selected role in a plurality of roles and historic operational data associated with the selected role, the historic operational data comprising at least one of transaction data and foot traffic patterns within an item selection area, the budget plan comprising a plurality of hours allocated to the selected role at a selected location for a selected time-period;
a month splitter component, implemented on the at least one processor, analyzes the budget plan and live metric data associated with scheduled operations at the item selection area using a set of per-role weighted configuration criteria and forecast metrics, the set of per-role weighted configuration criteria assigning a percentage weight to each metric in the forecast metrics;
the month splitter component allocates a set of hours from the plurality of hours to each day in a plurality of days based on a result of the analysis;
an intra-day splitter component, implemented on the at least one processor, spreads the set of hours for a selected day across a set of time-segments for the selected day based on a selected forecast spreading routine, the selected forecast spreading routine comprising a metric spreading routine; and
a smoothing component, implemented on the at least one processor, performs rounding and smoothing across a user-selected time window to reduce spikes and gaps in the set of hours spread across the user-selected time window while ensuring an exact match with the budget plan.

2. The system of claim 1, further comprising:
a seasonal metric associated with the selected role, wherein the week splitter component allocates the set of hours to each day in the plurality of days based on the seasonal metric.

3. The system of claim 1, further comprising:
a fixed demand metric associated with the selected role, wherein the week splitter component allocates the set of hours to the selected day within the plurality of days based on a fixed demand task associated with the selected day.

4. The system of claim 1, further comprising:
a rounding threshold, wherein the week splitter component allocates the set of hours to each day in the plurality of days based on a rounding value and the rounding threshold, wherein the rounding threshold rounds labor demand during a week allocation in accordance with a threshold time segment; and
a configuration option, wherein the week splitter component re-allocates all remaining hours from rounding to a first selected role on another day in a week associated with the selected day or to a second selected role in the plurality of roles.

5. The system of claim 1, further comprising:
a rounding value, wherein the week splitter component rounds a fractional value to a whole value based on the rounding value.

6. The system of claim 1, further comprising:
an offsetting component, implemented on the at least one processor, calculates a per-day demand based on a first set of metrics during a first portion of a per-day demand calculation and a second set of metrics during a second portion of the per-day demand calculation.

7. The system of claim 1, further comprising:
a week splitter component, implemented on the at least one processor, re-splits the set of hours allocated to each day in a selected month to each week in the selected month based on a set of weekly goals for the selected role, per-week live metric data and the forecast metrics; and
the week splitter component re-splits the set of hours to each day in a selected week based on the set of weekly goals for the selected role, the per-week live metric data and a set of event-driven metrics, the set of event-driven metrics comprising at least one metric associated with variable demand during holidays and local events associated with the item selection area.

8. The system of claim 1, further comprising:
a coverage-fill component, implemented on the at least one processor, allocates remainders to at least one time-segment of the selected day having a lowest demand coverage; and
an edge-fill component, implemented on the at least one processor, allocates remainder time-segments on an edge of a demand curve having a highest rounding error until all remainder time-segments have been allocated.

9. The system of claim 1, further comprising:
a validation component, implemented on the at least one processor, compares a generated per-role allocation of hours for each day in a given time-period with the budget plan for the selected role during the given time-period, wherein the validation component validates the generated per-role allocation of hours for the selected role if a number of hours allocated to the selected role during the plurality of days in the given time-period is equal to the number of hours budgeted for the selected role during the given time-period.

10. A computer-implemented method for budget driven labor demand allocation, the computer-implemented method comprising:
retrieving, from a data storage device, a budget plan associated with a selected role in a plurality of roles, the budget plan comprising a plurality of goal hours allocated to the selected role at a selected location for a selected time-period;
analyzing, by a week splitter component, the budget plan and live metric data associated with an item selection area using a set of per-role configuration criteria, historic operational data associated with the selected role and a set of per-role metric weights;
allocating, by the week splitter component, a set of hours from a plurality of hours to each week in a set of weeks based on a result of the analysis and the live metric data associated with scheduled operations at the item selection area, the live metric data comprising a weekly item delivery schedule for the item selection area;
re-splitting, by the week splitter component, the set of hours allocated to a selected week to each day associated with the selected week;
spreading, by an intra-day splitter component, the set of hours across a set of time-segments for a selected day based on a selected forecast spreading routine;
validating, by a validation component, a set of per-role allocation hours conforms with the budget plan during the selected time-period; and
outputting, by an assignment component, the set of per-role allocation hours to the selected role on condition the set of per-role allocation hours are validated based on the budget plan.

11. The computer-implemented method of claim 10, wherein the selected forecast spreading routing comprises a midpoint spreading routine, and further comprising:
spreading hours in a first set of hours beginning at a user-configurable mid-point time segment allocating hours equally on both sides of the user-configurable mid-point time segment, wherein the hours are spread away from the user-configurable mid-point time segment toward a first end-point and a second end-point until all hours in the first set of hours are allocated.

12. The computer-implemented method of claim 10, wherein the selected forecast spreading routing comprises an end-points spreading routine, and further comprising:
spreading hours in a first set of hours from a user-configurable first end-point and a user-configurable second end-point equally toward a mid-point until all hours in the first set of hours are allocated.

13. The computer-implemented method of claim 10, further comprising:
adding, by a coverage-fill component, at least one remainder time-segment to a lowest demand level during a selected time window beginning at a last edge for the selected day, wherein the coverage-fill component adds a time segment to each edge based on a set of edges with a highest rounding error until there are no un-allocated remainder time-segments remaining.

14. The computer-implemented method of claim 10, further comprising:
calculating, by an offsetting component, a per-day demand associated with the selected role and the item selection area based on a first set of metrics during a first portion of a per-day demand calculation and a second set of metrics during a second portion of the per-day demand calculation.

15. The computer-implemented method of claim 10, further comprising:
edge-filling, by a smoothing component, implemented on the at least one processor, across a user-selected time window to reduce spikes and gaps in the set of hours spread across the user-selected time window to generate a set of per-role allocation hours for each day during the selected time-period.

16. A system for customized per-role labor demand allocation, the system comprising:
a memory;
at least one processor communicatively coupled to the memory;
an intra-day splitter component, implemented on the at least one processor, allocates a set of hours available to a selected role on a selected day across a set of time-segments for the selected day based on a selected forecast spreading routine, the selected forecast spreading routine comprising a midpoint spreading routine or an end-points spreading routine;
a validation component, implemented on the at least one processor, compares a set of per-role allocation hours with the budget plan to verify the set of per-role allocation hours conforms with goal hours provided by the budget plan during a selected time-period; and
an assignment component, implemented on the at least one processor, assigns the set of per-role allocation hours to the selected role on condition the set of per-role allocation hours are validated based on the budget plan.

17. The system of claim 16, further comprising:
a smoothing component, implemented on the at least one processor, performs rounding and smoothing across a user-selected time window to reduce spikes and gaps in the set of hours spread across the user-selected time window to generate the set of per-role allocation hours for each day during the selected time-period.

18. The system of claim 16, further comprising:
a coverage-fill component, implemented on the at least one processor, adds remainder time-segments to a lowest demand level during a user-selected time window beginning at a last edge for the selected day, wherein the coverage-fill component adds a time segment to each edge until there are no un-allocated remainder time-segments remaining to generate the set of per-role allocation hours for each day during the selected time-period.

19. The system of claim 16, wherein the selected forecast spreading routing comprises the end-points spreading routine, and further comprising:
the intra-day splitter, implemented on the at least one processor, spreads hours in a first set of hours beginning at a first end-point toward a mid-point until all hours in the first set of hours are allocated and spreads a second set of hours from a second end-point toward the midpoint until all hours in the second set of hours are allocated to a time-segment.

20. The system of claim 16, wherein the selected forecast spreading routing comprises a midpoint spreading routine, and further comprising:
the intra-day splitter, implemented on the at least one processor, spreads hours in a first set of hours beginning at a mid-point toward a first end-point until all hours in the first set of hours are allocated and spreads a second set of hours from the mid-point toward a second end-point until all hours in the second set of hours are allocated to a time-segment.
